(19) United States
(12) Patent Application Publication
(10) Pub. No.: US 2023/0193010 A1
(43) Pub. Date: Jun. 22, 2023

(54) Pipe Including a Polymethylpentene Thermoplastic Polymer

(71) Applicant: Celanese International Corporation, Irving, TX (US)

(72) Inventors: Krishnan Anantha Narayana Iyer, Manvel, TX (US); Dinara Sunagatullina, Houston, TX (US)

(21) Appl. No.: 17/923,433

(22) PCT Filed: Apr. 26, 2021
(86) PCT No.: PCT/US2021/029090

§ 371 Date: Nov. 4, 2022

Related U.S. Application Data
(60) Provisional application No. 63/020,456, filed on May 5, 2020.

(51) Int. Cl. C08L 23/22; C08L 23/12; C08L 23/16

(52) U.S. Cl. CPC C08L 23/22; C08L 23/12; C08L 23/16; C08L 2205/025; C08L 2205/03; C08L 2203/18

(57) ABSTRACT

In an embodiment is provided a thermoplastic vulcanizate (TPV) composition that includes a rubber and a thermoplastic polyolefin, the thermoplastic polyolefin comprising a polymethylpentene. In another embodiment is provided a pipe, wherein the pipe includes a TPV composition. In another embodiment is provided an insulated high-temperature transport conduit that includes a TPV composition. In another embodiment is provided a pipe that includes a thermal insulation layer comprising a TPV composition. In another embodiment is provided a process for preparing a TPV composition, the process includes melt processing under shear conditions at least one thermoplastic polyolefin, at least one rubber, and at least one curing agent, the at least one thermoplastic polyolefin comprising polymethylpentene; and forming a TPV composition.

### CROSS-REFERENCE TO RELATED APPLICATIONS

This application claims the priority benefit of U.S. Ser. No. 63/020,456, filed May 5, 2020, which is incorporated herein by reference.

### FIELD

Embodiments of the present disclosure generally relate to polymethylpentene (PMP) thermoplastic polymers and thermoplastic vulcanizate (TPV) compositions that include PMP thermoplastic polymers, and to their use in a layer of a pipe.

### BACKGROUND

Pipes, e.g., flexible pipes, are used to transport hydrocarbons and other fluids. The flexible pipe structures can include layers made of, e.g., polymeric, metallic, and composite layers. Flexible pipes typically include an internal pressure sheath that contacts the fluids being transported in the flexible pipe, an outer sheath that includes a polymer composition, and an annulus region between the inner sheath and outer sheath. The annulus region includes armoring layers (or reinforcing plies) that provide support for the inner pressure sheath and an intermediate sheath that has polymeric layer(s) supported by a reinforcement structure.

While fluid, e.g., hydrocarbons, flows through the flexible pipe, gases (such as CO₂, H₂S, methane, and water vapor) can diffuse through the inner pressure sheath and into the annulus region between the inner pressure sheath and the outer sheath of the flexible pipe. In the annulus region, the gases can accumulate and upon contact with water and/or moisture can form acidic conditions that cause corrosion of the typically metallic armoring layers. Such corrosion precipitates failure and breakdown of the flexible pipe and involves a costly shutdown of the fluid transport and replacement of the flexible pipe. In addition, excess buildup of gases and condensate in the annulus space can result in the rupture of the outer sheath when the interior pressure exceeds the pressure outside of the pipe. This risk is particularly high closer to the surface, when the hydrostatic pressure is lower.

To reduce (or eliminate) corrosion of the metallic elements in the flexible pipe, the polymer composition located in the intermediate sheath of the annulus region and/or the outer sheath should be permeable to acidic gases, e.g., CO₂ and H₂S. Moreover, because the polymer composition contacts the gases and external sea conditions, the polymer composition should exhibit various properties, e.g., good resistance to physical and chemical degradation, high temperature resistance, resistance to hydrolysis, good abrasion resistance, good crack propagation strength, and good fatigue strength.

In deep and ultra-deep water environments the low ocean floor temperature increases the risk of production fluids cooling to a temperature which may lead to pipe blockage. For example, cooling of crude oil can result in paraffin formation resulting in the blockage of the internal bore of the flexible pipe. The flexible pipe may further include a thermal insulation layer arranged between the reinforcing layers and the external protective sheath. This thermal insulation layer is generally made by helically winding of syntactic foams. Such syntactic foams consist of a polypropylene matrix with embedded non-polymeric (e.g., glass) microspheres. A major disadvantage for such syntactic polypropylene foam tapes is that they involve two manufacturing steps: producing the insulation tape and winding the tape onto the pipe body. A further disadvantage of such extruded tapes includes the corrosion of steel or metal wires forming the layers due to condensation of water vapor migrating from the inner layer through the insulation tapes. A still further disadvantage of existing insulation technology is that in the case of damage to the external sheath, the annulus of the flexible pipe can get flooded which increases the risk of corrosion of the metal armor wires. Moreover, conventional extruded insulation layers composed of foamed polymeric insulation layers, however, are prone to crushing under internal and external pressures, and such pressures can squeeze the tape layer thereby reducing its thickness and thermal insulation properties.

Therefore, there is a need for a highly permeable polymer composition, and its application in one or more layers of flexible pipes, the composition having a balanced combination of mechanical and physical properties that can reduce (or eliminate) the build-up of acidic gases in the annulus region of flexible pipes. There is also a need for thermal insulation layers having improved thermal insulation properties.

### SUMMARY

In an embodiment is provided a thermoplastic vulcanizate composition that includes a rubber and a thermoplastic polyolefin, the thermoplastic polyolefin comprising a polymethylpentene, the rubber being at least partially crosslinked.

In another embodiment is provided a process for preparing a thermoplastic vulcanizate composition, the process includes melt processing under shear conditions at least one thermoplastic polyolefin, at least one rubber, and at least one curing agent, the at least one thermoplastic polyolefin comprising polymethylpentene; and forming a thermoplastic vulcanizate composition.

In another embodiment is provided an insulated high-temperature transport conduit that includes a continuous steel pipe comprising one or more pipe sections, wherein the steel pipe has an outer surface and an inner surface; and a first thermal insulation layer disposed over the outer surface of the steel pipe, wherein the first thermal insulation layer comprises a TPV composition having a thermal conductivity of less than 0.2 W/m·K.

In another embodiment is provided a pipe that includes an inner polymer sheath; one or more reinforcing layers; one or more internal polymer sheaths, the internal polymer sheaths being one or more outer protective sheaths, one or more intermediate sheaths, or a combination thereof; and an external polymer sheath, wherein the inner polymer sheath, the one or more internal polymer sheaths, the external polymer sheath, or a combination thereof comprises a TPV composition.

In another embodiment is provided a pipe that includes a thermal insulation layer comprising a TPV composition.

In another embodiment is provided an article that includes a thermal insulation layer comprising a TPV composition. The article further includes an electric vehicle car battery, an electronic, a heater, or a combination thereof.

Other and further embodiments are described below.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, for the disclosure may admit to other equally effective embodiments.

FIG. 1A shows a transverse cross-section of an insulated pipe according to at least one embodiment.

FIG. 1B shows a transverse cross-section of an insulated pipe according to at least one embodiment.

FIG. 1C shows a transverse cross-section of an insulated pipe according to at least one embodiment.

FIG. 1D shows a transverse cross-section of an insulated pipe according to at least one embodiment.

FIG. 2 shows a side view of an example flexible pipe according to some embodiments.

To facilitate understanding, identical reference numerals have been used, where possible, to designate identical elements that are common to the figures. It is contemplated that elements and features of one example may be beneficially incorporated in other examples without further recitation.

### DETAILED DESCRIPTION

Embodiments of the present disclosure generally relate to polymethylpentene (PMP) compositions and TPV compositions, and to uses of such composition(s) in one or more layers of a flexible pipe (e.g., an outer sheath and/or an intermediate sheath). The inventors have surprisingly found that such compositions, relative to conventional polymers, achieve higher gas permeability, lower thermal conductivity, and lower weight, while retaining good tensile properties. The metal elements and materials included within the flexible pipe are better protected from the corrosion of the acidic gases because the PMP compositions and TPV compositions described herein advantageously provide better gas permeability as the gas diffuses faster through the layers of the flexible pipe. Flexible pipes made from the PMP compositions and/or TPV compositions described herein are lighter in weight than flexible pipes made from conventional materials because the lower density of the example compositions described herein. Further, flexible pipes made from the PMP compositions and/or TPV compositions described herein can be lighter in weight because of the lower thermal conductivity of the example PMP compositions and TPV compositions. The lower thermal conductivity of such materials can enable a reduction in the amount of insulation materials, thereby reducing the weight of the pipe. The reduced amount of insulation also provides for a pipe of reduced thickness relative to pipes made of conventional materials.

For purposes of this disclosure, the terms “conduit”, “pipe”, “hose”, and “tube” can be used interchangeably.

For purposes of this disclosure, the terms “housing”, “sheath”, and “layer” can be used interchangeably.

For purposes of this disclosure, the terms “armoring layers,” “armoring elements,” and “reinforcing plies” can be used interchangeably.

For purposes of this disclosure, and unless otherwise indicated, a “composition” includes components of the composition and/or reaction products of two or more components of the composition.

For the purposes of this present disclosure, and unless otherwise specified, all numerical values within the detailed description and the claims herein are modified by “about” or “approximately” the indicated value, and consider experimental error and variations that would be expected by a person having ordinary skill in the art.

Flexible pipes can be used to transport fluids, e.g., for offshore petroleum production, between oil and gas reservoirs for separation of oil, gas, and water components. Flexible pipes are generally formed as an assembly of a pipe body and one or more fittings, the pipe body including, e.g., polymeric, metallic, and/or composite layers.

The pipe body of a typical flexible pipe useful for this purpose can include at least one inner layer that forms an impervious sheath for fluid and pressure containment. The pipe structure can allow large deformations without causing (or minimizing) bending stresses that can impair the pipe's functionality over an extended period of time. The flexible pipe design can also include one or more tensile armor layers that provide structural integrity to the pipe. An outer polymeric sheath is generally provided over the reinforcing layers. The outer sheath is typically responsible for providing flexibility while preventing corrosion and mechanical wear of inner layers. A layer of thermal insulation can be provided around the barrier layer (e.g., inner polymer sheath) of a flexible pipe to prevent formation of paraffins or hydrides due to cold ocean temperatures.

Because the inner pressure sheath serves to contain fluids, the use of materials resistant to physical and chemical degradation throughout the entire service life of the flexible pipe (e.g., 20-30 years) is a consideration in developing materials for inner pressure sheaths. Another criterion for the inner pressure sheath material is low permeability to various gases included in the fluids transported by the pipe, so as to minimize corrosion of carbon steel layers. Conventional materials for various layers of the pipe body include polyamide-11 (PA11), polyamide-12 (PA12), polyvinylidene fluoride (PVDF), high density polyethylene (HDPE), and syntactic foams which can be made of a polypropylene or polyurethane matrix with embedded non-polymeric (e.g., glass) (hallow) microspheres. Historically, PA11 and PA12 have been the most widely used materials for pressure sheaths in the offshore industry. However, aging of PA11 and PA12 due to hydrolysis is still not well understood after some 20 years of testing, and the lack of good aging predictive models translates to integrity management issues of operated flexible pipe assets installed worldwide.

Thermoplastic umbilical hoses are used to control subsea equipment via hydraulic fluids, electrical and optic fiber cables, as well as for gas lift, or injection of chemicals into oil and gas reservoirs. Many hoses achieve fluid containment with PA11 material grades similar to those employed in flexible pipes, which leads to similar aging problems and integrity management concerns.

Conventional materials for insulation layers exhibit certain disadvantages. Although flexible pipes have enabled deep-water oil explorations at depths of about 3,300 feet, there is a need to develop polymers that can be employed in such pipe constructions for applications at even greater depths. In such deep and ultra-deep water environments, extremely low ocean floor temperatures increase the risk for formation of hydrides and paraffins resulting in pipe blockage. For example, when transporting crude oil, blockage of the inner polymeric tube can occur due to formation of paraffins. Conventional materials used for the intermediate sheath 3 include a single extruded layer or helically wrapped layers of extruded tapes of syntactic foams consisting of a polypropylene or polyurethane matrix with embedded non-polymeric (e.g., glass) (hallow) microspheres, HDPE, and PVDF. A major disadvantage for such syntactic PP foam tapes is that they involve two manufacturing steps: producing the insulation tape and winding the tape onto the pipe body. A further disadvantage of such extruded tapes includes the corrosion of steel or metal wires forming the layers due to condensation of water vapor migrating from the inner layer through the insulation tapes. A still further disadvantage of existing insulation technology is that in the case of damage to the external sheath, the annulus of the flexible pipe can get flooded which increases the risk of corrosion of the metal armor wires. Moreover, such foamed polymeric insulation layers are prone to crushing under internal and external pressures, and such pressures can operate to squeeze the tape layer thereby reducing its thickness and thermal insulation properties. The crushing of the glass beads in the syntactic foams can result in deterioration of insulation properties (increase of thermal conductivity) over time. As a result, the design of a thicker insulation layer to maintain the insulation performance over a period of time (e.g., 10 years) increases the cost of manufacture and the weight of the pipe. Therefore, there is significant interest in providing an extrudable, dense thermal insulation layer with high permeability, and acceptable insulation properties.

Conventional materials for outer sheaths also exhibit certain disadvantages. Conventional materials used for the outer sheath include high density polyethylene (HDPE), polyamide-11 (PA11), and polyamide-12 (PA12). The current polymeric materials used for outer sheaths have extremely low permeability for acidic gases, thereby further exacerbating the corrosion. Conventional materials also show poor low temperature properties, poor crack propagation strength, limited fatigue strength, among other negative characteristics. These drawbacks have necessitated such materials to be compounded with plasticizers, such as n-butylbenzenesulfonamide (BBSA) that can migrate overtime resulting in embrittlement of the outer sheath layer. The outer sheath serves as a protective barrier against the external environment, serves as a thermal barrier against cold ocean temperatures, and prevents corrosion of inner tensile armors. The outer sheath thus experiences a high temperature difference between the inside of the pipe (e.g., up to about 90° C.) and the cold temperatures of the ocean floor (e.g., down to about 4° C.). When hanging from the platform, the outer layer can also experience significant UV exposure and deterioration from ocean spray. The pipes may also face problems of tearing or abrasion associated especially with their handling when the pipes are laid and from constant dynamic motion caused by waves. Moreover, their direct contact with the marine environment raises problems of resistance to hydrolysis for conventional polymers, such as polyamides, polyesters or copolyamides. Since the service life of offshore tubular pipes is calculated for a field life of up to 20 years, it is necessary to ensure that the outer sheaths are capable of withstanding the abovementioned stresses throughout this period. In addition, the cold ocean temperatures can lower the temperature below the dew point of water in the annulus region between outer sheath and inner polymer sheath. The acidic gases, such as CO₂ and H₂S, permeating through inner bore can migrate toward the outer sheath to combine with this water and produce a corrosive environment for the tensile layers. Conventional polymeric materials used for outer sheaths, such as polyamides and copolyamides, have relatively low permeability for gases and therefore suffer from constant failures, including fatigue cracking, embrittlement, etc. that ultimately reduce the pipe's service life. Outer sheaths made of HDPE have better abrasion resistance, however such sheaths lack flexibility and flex fatigue resistance.

To overcome the deficiencies mentioned above for both insulation and outer sheath layers, there is a need for replacing the traditionally used materials (e.g., PA11, PA12, syntactic foam, HDPE) with new materials that have several performance characteristics including sufficiently low thermal conductivity (thus excellent insulating performance that is maintained over a long period of time), light weight, high permeability to prevent accumulation of acidic gases in the annular space between the outer sheath and the inner polymer sheath, excellent abrasion resistance, and/or outstanding creep properties (to withstand high stresses).

### Articles

Certain PMP compositions and TPV compositions of the present disclosure can be used to form a layer made by extrusion and/or co-extrusion, blow molding, injection molding, thermo-forming, elasto-welding, compression molding and 3D printing, pultrusion, and other fabrication techniques. The layer can be co-extruded as a separate layer, or extruded as a tape and wrapped onto the pipe (e.g., a flexible pipe), such as an anti-wear layer or an insulation layer (e.g., a thermal insulation layer). The layer can be part of a flexible structure used to transport hydrocarbons extracted from an offshore deposit and/or can transport water, heated fluids, and/or chemicals injected into the formation in order to increase the production of hydrocarbons.

Certain PMP compositions and TPV compositions of the present disclosure can be configured for use as at least a portion of a conduit can have a thickness in the range of from about 2 millimeters (mm) to about 30 mm, encompassing any value and subset there between.

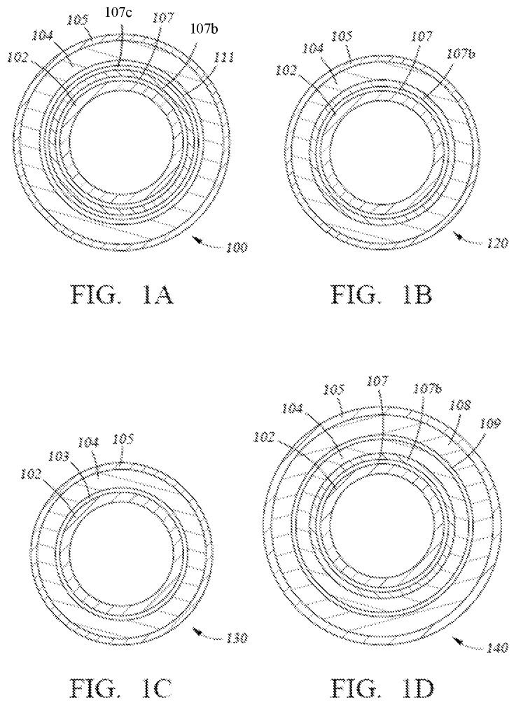

FIG. 1A shows a transverse cross-section of an example insulated oil and gas pipeline 100 according to at least one embodiment of the present disclosure. The insulated pipeline 100 can include one or more sections of pipe 102 in which the insulating and protective coating can include a three-layer corrosion protection system. According to this system, the steel pipe 102 can be coated with a corrosion protection layer 107 that can include cured epoxy, and/or an intermediate first adhesive layer 107b applied over the corrosion protection layer 107, and/or a first protective topcoat 107c applied over the first adhesive layer 107b. The first protective topcoat 107c can provide added corrosion and mechanical protection, and the optional adhesive layer 107b can provide an adhesive bond between the topcoat 107c and the underlying corrosion protection layer 107. The topcoat 107c is shown in FIG. 1A as a thin layer between the optional adhesive layer 107b and the overlying insulation layers (e.g., 106) described below. The composition and thickness of the topcoat 107c can at least partially depend on the compositions of the underlying optional adhesive layer 107b and the overlying insulation layers, particularly with respect to adhesion to those layers. In some embodiments, a second adhesive layer 111 can be optionally used. In terms of composition, the topcoat can include an extrudable thermoplastic resin, or can include the same material as an overlying thermal insulation layer, or a material compatible with or bondable to the thermal insulation layer, including a blend of two or more materials.

In some embodiments, an outer protective topcoat 105 can be applied over the outer layer of insulation to provide further resistance to static pressure at great depths, for example, when said outer layer of insulation is foamed. The outer protective topcoat 105 can, for example, include the same polymeric material as one or more of the thermal insulation layers but can be a solid, unfoamed state. For example, where the outer layer of insulation (e.g., layer 104) includes a foamed polystyrene, styrene-based thermoplastic, a TPV composition, a PMP composition, or a combination thereof, and the outer protective topcoat 105 can include a solid, unfoamed polystyrene, styrene-based thermoplastic, a TPV composition, a PMP composition, or a combination thereof.

FIG. 1B shows a transverse cross-section of an example insulated oil and gas pipeline 120 according to at least one embodiment of the present disclosure. The insulated pipeline 120 can include one or more sections of steel pipe 102 provided with a two-layer corrosion protection system, wherein the steel pipe 102 can be provided with a corrosion protection layer 107 comprising a cured epoxy and a first adhesive layer 107b applied over layer 107, as in FIG. 1A. In the corrosion protection system shown in FIG. 1B, the first adhesive layer 107b can double as both adhesive and topcoat, thereby eliminating the need for the separate application of a first protective topcoat 107c. A similar two-layer corrosion protection system is shown in FIG. 1D which illustrates a transverse cross-section of an insulated oil and gas pipeline 140 according to another embodiment.

As an alternative to the multi-layer corrosion protection systems illustrated in FIGS. 1A and 1B, the steel pipe 102 can instead be provided with a single-layer composite corrosion protection layer wherein the epoxy, adhesive and polymer topcoat components are pre-mixed and applied onto the pipe 1 as a variably graded coating. FIG. 1C illustrates a transverse cross-section of an example insulated oil and gas pipeline 130 according to at least one embodiment of the present disclosure. The insulated pipeline 130 can include one or more sections of pipe 102 provided with such a single-layer composite corrosion protection coating 103.

In the insulated oil and gas pipelines according to some embodiments of the present disclosure, the insulating and protective coatings can include one or more thermal insulation layers, which can include one or more foamed layers and/or one or more unfoamed (solid) layers. The example pipelines 100, 120, and 130 illustrated in FIGS. 1A-1C include a single thermal insulation layer 104, whereas other pipelines (e.g., 140 of FIG. 1D) can be provided with first (inner) and second (outer) thermal insulation layers 104. It will also be appreciated that insulated oil and gas pipelines according to the present disclosure can include more than two layers of thermal insulation, each of which can be foamed or unfoamed.

As shown in FIG. 1D, the insulating and protective coating can include more than one thermal insulation layer of the same TPV composition (and/or PMP composition) foamed to different degrees, or densities, or it can include more than one thermal insulation layer of solid or foam made from dissimilar TPV materials (and/or PMP materials). This can allow the system to be tailored for precise thermal insulation performance related to the end application. For example, a TPV or PMP with higher temperature resistance or softening point can be used as an inner foam or solid thermal insulation layer closest to the hot steel pipe with lower temperature resistant and lower thermal conductivity TPV or PMP, as an outer secondary, or tertiary, insulation layer.

Embodiments illustrated by FIG. 1D, can include an inner foam insulation layer 104 and an outer foam insulation layer 108 which can be of the same or different composition and/or density. The foam insulation layers 104 and 108 can be separated by a layer 109 of unfoamed polymeric material which can be of the same or different composition as either one or both of the layers 104 and 108. It will be appreciated that an adhesive layer can be provided between the foam layers 104, 108 or between one or more of foam layers 104, 108 and the adjacent unfoamed layer 109. It will be appreciated that the unfoamed layer 109 may not be necessary in all situations, for example where individual foam insulation layers are bonded directly to one another.

In at least one embodiment, one or more layers of a pipe (such as that described in FIGS. 1A-1D), can include a PMP thermoplastic polymer, a TPV composition that includes a PMP thermoplastic polymer, or a combination thereof.

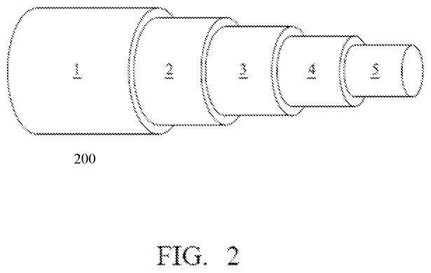

FIG. 2 shows, schematically, a side view of an example flexible pipe 200 according to some embodiments. The flexible pipe can include from inside out an inner polymer sheath 5, a first armor layer 4, an intermediate sheath 3, a second armor layer 2, and an outer sheath 1. The inner polymer sheath 5 can contact the oil and/or gas. The first armor layer 4 can provide strength to the tube and can be made from, for example, one or more layers of metal and/or reinforced polymer (e.g., carbon nanotube reinforced polyvinylidene fluoride (PVDF)). Intermediate sheath 3 can provide thermal insulation and/or anti-wear resistance. The intermediate sheath 3 can be extruded as a single layer or extruded as a tape and then wrapped on to the flexible pipe. Second armor layer 2 can provide strength and pressure resistance to the tube and can be made from, for example, one or more layers of metal. Outer sheath 1 can protect the pipe structure and has the properties of abrasion resistance and fatigue resistance. The outer sheath 1, intermediate sheath 3, and/or inner polymer sheath 5 can be made from a material that includes one or more TPV compositions, one or more PMP compositions, or a combination thereof, as described below.

In at least one embodiment, one or more layers of a pipe as described in FIG. 2, can include a PMP thermoplastic polymer, a TPV composition that includes a PMP thermoplastic polymer, or a combination thereof.

In at least one embodiment, reinforcing layers (or armor layers) can be formed from coils of a reinforcing wires or of metallic strips or of long composite elements.

Conventional materials used for the outer sheath 1 include high density polyethylene (HDPE), polyamide-11 (PA11), and polyamide-12 (PA12). The current polymeric materials used for outer sheaths have extremely low permeability for the acid gases, thereby further exacerbating corrosion of the pipe structure. Conventional materials also show poor low temperature properties, poor crack propagation strength, limited fatigue strength, among other negative characteristics. These drawbacks have necessitated such materials to be compounded with plasticizers, such as n-butylbenzenesulfonamide (BBSA) that can migrate overtime resulting in embrittlement of the outer sheath layer.

Conventional materials used for the intermediate sheath 3 include a single extruded layer or helically wrapped layers of extruded tapes of syntactic foams consisting of a polypropylene or polyurethane matrix with embedded non-polymeric (e.g., glass) (hallow) microspheres, HDPE, and PVDF. A major disadvantage for such syntactic PP foam tapes is that they involve two manufacturing steps: producing the insulation tape and winding the tape onto the pipe body. A further disadvantage of such extruded tapes include the corrosion of steel or metal wires forming the layers due to condensation of water vapor migrating from the inner layer through the insulation tapes. A still further disadvantage of existing insulation technology is that in the case of damage to the external sheath, the annulus of the flexible pipe can get flooded which increases the risk of corrosion of the metal armor wires. Moreover, such foamed polymeric insulation layers are prone to crushing under internal and external pressures operate to squeeze the tape layer thereby reducing its thickness and thermal insulation properties. Therefore, there is significant interest in providing an extrudable, dense thermal insulation layer with high permeability, and acceptable insulation properties.

A certain class of thermoplastic polymers and a certain class of TPVs have been surprisingly found to provide an alternative and more robust material for one or more layers (e.g., the outer sheath and/or intermediate sheaths) described herein. As discussed below, and according to some embodiments, the thermoplastic polymers can include polymethylpentene (PMP) thermoplastic polymer. As discussed below, and according to some embodiments, the TPVs can include a PMP thermoplastic polymer.

### 1. Corrosion Protection Coating(s)

It can be advantageous to apply one or more corrosion protection layers or a multi-layer corrosion protection system to the steel pipe prior to any subsequent layers. The initial corrosion protection layer, namely that coating bonded directly to the steel pipe, can include a cured epoxy, or modified epoxy, which can be applied onto a cleaned and pre-heated pipe surface (a) as a fusion bonded powder by spraying the pipe with powder-spray guns, passing the pipe through a “curtain” of falling powder, or using a fluidized bed containing the powder, or, (b) as a liquid coating using liquid-spray guns. Curing of the epoxy can result from contact with the hot pipe. The cured epoxy, or modified epoxy can be applied by other methods known in the art.

It can be advantageous to apply additional layers over the partially cured epoxy. In a 3-layer corrosion protection system, an olefin-based adhesive copolymer, for example a maleic anhydride functionalized polyolefin, can be applied directly to the partially cured epoxy, followed by the application of a polymer topcoat over the adhesive for mechanical protection. The function of the adhesive is to bond the topcoat or the first thermal insulation layer to the epoxy corrosion protection layer. The adhesive and polymer topcoat can be applied by extrusion side-wrap or by powder spray methods.

The adhesive layer can also include a coextruded structure of two or more layers, the outer layers of which will bond to the respective corrosion protection layer and subsequent topcoat or thermal insulation layer with which they are compatible.

As alternatives to the cured epoxies mentioned above, the corrosion protection layer can instead (or additionally) include modified epoxies, epoxy phenolics, modified styrene-maleic anhydride copolymers such as styrene-maleic anhydride-ABS (acrylonitrile-butadiene-styrene) blends, polyphenylene sulphides, polyphenylene oxides, or polyimides, including modified versions and blends thereof. In some cases, an adhesive layer is not used to bond these corrosion protection coatings to the pipe or to the topcoat or first insulation layer. Some of these materials can also be used at higher service temperatures than the epoxy-based corrosion protection systems described above.

Some of the higher temperature-resistant corrosion protection coatings mentioned above can also have properties which make them suitable for use as thermal insulation layers in any of the embodiments of the present disclosure. While the corrosion protection coating can include a different polymer grade having different properties, it is conceivable that the same type and grade of polymer can be used for both corrosion protection and thermal insulation. In this case, a single layer of this polymer can serve as both corrosion protection coating and thermal insulation layer.

### 2. Additional Adhesive Layer(s)

In at least one embodiment and in cases where an adhesive layer is used, e.g., where an adhesive layer is applied between adjacent thermal insulation layers or between a thermal insulation layer and one or more of the other layers, including any solid protective layers and topcoats, particularly layers of dissimilar composition, the adhesive material can bond equally well to said layers. The adhesives used can be polymers with functionalities having mutual affinity to the layers requiring bonding, the functionalities being specific to the chemical composition of the layers requiring bonding. In some embodiments, the bond strength can be high enough to promote cohesive failure between the individual layers.

In at least one embodiment, the adhesive layer can also include a coextruded structure of two or more layers, the outer layers of which will bond to the respective insulation layers or topcoats with which they are compatible.

In at least one embodiment, the adhesive layer between adjacent thermal insulation layers and between a thermal insulation layer and one or more of the other layers can, for example, include a grafted polymer or copolymer, or polymer blend with one or more moieties compatible with each of the individual layers to be bonded.

In at least one embodiment, the adhesive layer can be applied by powder spray application, or side-wrap, crosshead extrusion or co-extrusion methods.

In at least one embodiment, an additional adhesive layer may not be used, such as in cases where the two adjacent layers have a mutual affinity for each other, or where it is possible to achieve bonding of the layers using plasma or corona treatment.

### 3. Thermal Insulation Layer(s) and Protective Topcoat

The insulating layers (e.g., thermal insulation layer, e.g., layer 104, and pipe joint insulation, e.g., layer 106) used in the present disclosure can include a TPV composition and/or PMP composition described herein. The insulating layers can be designed to withstand operating temperatures in excess of the maximum operating temperatures (about 130° C.) of systems currently used for the thermal insulation of subsea pipelines, such as polypropylene. These operating temperatures can be as high as 200° C. The thermal insulation layers can also be designed to exhibit adequate compressive creep resistance and modulus at these temperatures to prevent collapse of the foam structure in deep water installations, and hence maintain the required thermal insulation over the lifetime of the oil and gas recovery project. In addition, the compositions can be sufficiently ductile to withstand the bending strains experienced by the insulated pipe during reeling and installation operations.

In at least one embodiment, a thermal insulation layer and/or a pipe joint insulation comprises, consists essentially of, or consists of a TPV composition described herein, a PMP composition described herein, or a combination thereof.

In at least one embodiment, the thermal insulation layer can include a composition, the composition comprising a thermoplastic olefin and a rubber, the composition having a high temperature resistant thermoplastic elastomer/thermoplastic vulcanizate having low thermal conductivity, high thermal softening point, high compressive strength, and/or high compressive creep resistance.

In at least one embodiment, one or more of the thermal insulation layers can also be provided with an additional protective layer, or topcoat, such as layer 105, comprising an unfoamed polymeric material. The protective layers can be prepared from the same material as the underlying thermal insulation layer, or a modified or reinforced version thereof.

In some embodiments, the outer protective topcoat can be made from a polymeric material having superior impact, abrasion, crush or chemical resistance to that from which the thermal insulation layer, or layers, is made. This can help impart a higher degree of physical or chemical performance, such as impact, abrasion, crush or moisture resistance, to the outer surface of the insulated pipe. Such a polymeric material can include the thermal insulation material blended with suitable polymeric modifiers, compatibilizers, or reinforcing fillers or fibers, or it can include a dissimilar, or compatible, polymeric material. In some embodiments, no adhesive layer is used between the final thermal insulation layer and topcoat to effect adequate bonding of the two layers. In some embodiments, an adhesive layer can be used between the final thermal insulation layer and topcoat to effect adequate bonding of the two layers.

In at least one embodiment, the insulation layers can include dissimilar materials, or materials foamed to different degrees. For example, a TPV composition and/or a PMP composition with a higher temperature resistance and/or softening point can be used as an inner unfoamed or foamed thermal insulation layer closest to the hot steel pipe to function as a heat barrier, and a TPV composition and/or a PMP composition having a lower temperature resistant and/or lower thermal conductivity unfoamed or foamed polymer as an outer secondary, or tertiary, thermal insulation layer.

In some embodiments, the thermal insulation layers can be foamed to different degrees the further they are away from the pipe wall. For example, outer layers of insulation can be foamed to progressively higher degrees than inner layers to provide tailored thermal performance of the system.

### 4. Foaming Agents

In some embodiments, foamed thermal insulation layers in the insulating and protective coatings according to the present disclosure can be prepared from TPV compositions and/or PMP compositions described herein, by incorporating chemical foaming agents, by, for example, the physical injection of gas or volatile liquid, or by blending with hollow polymer, glass or ceramic microspheres. In some embodiments, however, glass and/or ceramic microspheres are not used in the thermal insulation layers.

Foams generated through the action of chemical or physical foaming agents are generally referred to as “blown” foams. Foams containing hollow microspheres are referred to as “syntactic” foams. Syntactic foams can provide superior compressive creep and crush resistance than blown foams, but are generally less efficient thermal insulators and are considerably more expensive. A cost and performance optimized design may, for example, include one or more layers of syntactic foam surrounded by one or more layers of blown foam insulation.

Chemical foaming agents can function via either an endothermic (heat absorbing) or exothermic (heat generating) reaction mechanism. Chemical foaming agents can include sodium bicarbonate, citric acid, tartaric acid, azodicarbonamide, 4,4-oxybis(benzene sulphonyl) hydrazide, 5-phenyl tetrazole, dinitrosopentamethylene tetramine, p-toluene sulphonyl semicarbazide, and a combination thereof. In at least one embodiment, the chemical foaming agent can be an endothermic foaming agent, such as sodium bicarbonate blended with citric acid and/or tartaric acid.

Chemical foaming occurs when the foaming agent generates a gas, usually CO₂ or N₂, through decomposition when heated to a specific decomposition temperature. The initial decomposition temperature along with gas volume, release rate and solubility can be parameters when choosing a chemical foaming agent. For physical foaming, the gas or volatile liquid used can include CO₂, supercritical CO₂, N₂, air, helium, argon, aliphatic hydrocarbons, such as butanes, pentanes, hexanes and heptanes, chlorinated hydrocarbons, such as dichloromethane and trichloroethylene, and hydrochlorofluorocarbons, such as dichlorotrifluoroethane, and a combination thereof. In the case of volatile liquids, foaming occurs when the heated liquid vaporizes into gas. In at least one embodiment, the physical foaming agent can be supercritical CO₂.

In at least one embodiment, and if microspheres are used, the hollow microspheres can include glass, polymeric, or ceramic, including silica and alumina, microspheres. In at least one embodiment, the hollow microspheres can be lime-borosilicate glass microspheres.

### 5. Thermal Insulation Application Process

The thermal insulation layer(s) that include a TPV composition and/or a PMP composition described herein and/or other layer(s) that include a TPV composition and/or a PMP composition described herein can be applied as any layer outside of the pipe. For example, it can be applied as the layer touching the steel pipe or the layer furthest from the steel pipe.

In at least one embodiment, the foamed or unfoamed thermal insulation layer, or layers, and any unfoamed protective layers, can be applied to the steel pipe or a pipeline, such as over the corrosion protection coating, or coatings, by, e.g., a sidewrap extrusion process, crosshead extrusion process, or co-extrusion process.

In at least one embodiment, extrusion can be accomplished using single screw extrusion, either in single or tandem configuration, or by twin-screw extrusion methods. In the case of single screw extrusion, the extruder screw can be either single stage or 2-stage design.

In at least one embodiment, a single stage compression screw can be adequate for chemical foam extrusion whereby the foaming agent can be added as a pelleted concentrate or master batch which can be pre-mixed with the polymer to be foamed using a multi-component blender, for example, mounted over the main feed port of the extruder. The design of the screw can incorporate barrier flights and mixing elements to ensure effective melting, mixing, and conveying of the polymer and foaming agent.

With a 2-stage screw, and according to at least one embodiment, the first and second stages can be separated by a decompression zone, at which point a gas or liquid physical foaming agent can be introduced into the polymer melt via an injection or feed port in the extruder barrel. The first stage can act to melt and homogenize the polymer, and the second stage can act to disperse the foaming agent, cool the melt temperature, and increase the melt pressure prior to the melt exiting the die. This can also be accomplished by tandem extrusion, wherein the two stages are effectively individual single screw extruders, the first feeding into the second. A 2-stage screw can be used for the extrusion of polymers which have a tendency to release volatiles when melted, or are hygroscopic, the extruder barrel then being equipped with a vent port positioned over the decompression zone through which the volatiles or moisture can be safely extracted.

Twin screw extrusion can be used, for example, when the polymer to be foamed is shear sensitive, when the fillers other additives be incorporated into the insulation composition, or when extruding syntactic foams or blown foams prepared by the physical injection of a gas or liquid foaming agent. Since the twin screw design is typically modular, comprising several separate and interchangeable screw elements, such as mixing and conveying elements, it can offer great versatility with respect to tailoring the screw profile for optimum mixing and melt processing.

In some embodiments, and for syntactic foams, for example, the hollow microspheres can be fed directly into the polymer melt using a secondary twin-screw feeder downstream of the main polymer feed hopper. An additional consideration with syntactic foams is potential breakage of the hollow microspheres during extrusion of the foam. Shear and compressive forces inside the extruder can be minimized during processing of the foam to prevent this through judicious design of the extruder screw(s), barrels, manifolds and dies. Alternatively, and in some embodiments, no microspheres are used in the compositions.

In at least one embodiment, the static mixing attachment or gear pump can be inserted between the end of the screw and the die to further homogenize the melt, generate melt pressure, and minimize melt flow fluctuations.

In some embodiments, for chemically or physically blown foams, the degree of foaming can be dependent on the balance of thermal conductivity and compressive strength. Too high a degree of foaming can be detrimental to the compressive strength and creep resistance of the foam. In some embodiments, the TPV compositions and/or PMP compositions described herein can be foamed from about 5% to about 50%, such as from about 5% to about 30%, or about 10% to about 25%. The degree of foaming can be defined herein as the degree of rarefaction, i.e. the decrease in density, and can be defined as [(Dₘₐₜᵣᵢₓ−D_{foam})/Dₘₐₜᵣᵢₓ]×100. Expressed in this way, the degree of foaming reflects the volume percentage of gas under the assumption that the molecular weight of gas is negligible compared to that of the matrix, which is generally true. Alternatively, the degree of foaming can be measured visually by microscopic determination of cell density.

In some embodiments, with respect to the particular foam insulations described herein, the conditions of mixing, temperature and pressure can be adjusted to provide a uniform foam structure comprising very small or microcellular bubbles with a narrow size distribution evenly distributed within the polymer matrix, in order to ensure maximum compressive strength, thermal performance and compressive creep resistance of the insulation when subjected to high external pressures and pressures. Also, when extruding blown foam insulation the foaming can be prevented until the polymer exits the extrusion die.

In at least one embodiment, the actual coating of the pipe can be accomplished using an annular crosshead die attached to the thermal insulation extruder through which the pre-heated pipe, with a prior-applied corrosion protection layer or multi-layer corrosion protection system, is conveyed, the thermal insulation thereby covering the entire surface of the pipe by virtue of the annular die forming said thermal insulation into a tubular profile around the conveyed pipe.

Alternatively, and in some embodiments, the thermal insulation can be applied by a side-wrap technique whereby the thermal insulation can be extruded through a flat strip or sheet die. The thermal insulation can be extruded in the form of a sheet or tape which can then be wrapped around the pipe. In some embodiments, one can apply a number of wraps to achieve the required thermal insulation thickness and, hence, performance. The individually wrapped layers can be fused together by virtue of the molten state of the material being extruded. In some embodiments, one can preheat the outer surface of the previous layer to ensure proper adhesion of any subsequent layer.

In some embodiments, the application of thermal insulation by the side-wrap technique can involve wrapping the pipe as it is simultaneously rotated and conveyed forwardly along its longitudinal axis. It can also involve the application of a pre-extruded tape using rotating heads while the pipe is conveyed longitudinally but not rotated. In this particular case, the winding angle of the thermal insulation layers can be adjusted by varying the speed of pipe movement in the longitudinal direction and/or by varying the rotational speed of the pipe or the rotating heads. The tape can be wound in successive layers at opposite winding angles to maintain neutrality of the pipe, until the required thickness has been built up. Furthermore, it can be desired that the applied layers of thermal insulation do not become joined and that they are able to slide over each other with little resistance in order to avoid increasing bend stiffness or bend dynamics.

In some embodiments where an adhesive layer is applied between the corrosion protection layer, or system, and the thermal insulation layer, or between individual thermal insulation layers, this can be accomplished using either a single layer sheet or annular die, or a co-extrusion die whereby a multi-layer adhesive or the adhesive and thermal insulation layers are applied simultaneously. In some embodiments, the outer protective topcoat can be similarly applied.

TPV compositions useful in one or more layers of a flexible pipe or article can include a fully or partially crosslinked and/or cured rubber phase, a thermoplastic phase, a filler, a plasticizer (e.g., an oil), and a curative. The cured rubber phase can includes one or more of an ethylene-propylene rubber, a butyl rubber, a halobutyl rubber, a halogenated copolymer of a C₄ to C₇ isomonoolefin and a paraalkylstyrene, or a combination thereof, and the thermoplastic phase (e.g., a thermoplastic polyolefin) can include one or more of a polymethylpentene polymer.

Certain embodiments of the present disclosure include flexible pipes/conduits comprising polymeric layer sheaths, positioned as inner layers, intermediate layers (which can include a TPV composition and/or a PMP composition), and/or outer layers (which can include a TPV composition and/or a PMP composition) of: 1) unbonded or bonded flexible pipes, tubes and hoses similar to those described in American Petroleum Institute (API) Spec 17J and API Spec 17K, 2) thermoplastic hoses similar to those described in API 17E, and 3) thermoplastic composite pipes similar to those described in Det Norske Veritas (DNV) RP-F119. In some embodiments, a TPV composition and/or a PMP composition of the present disclosure can used in composite tapes (e.g., carbon fibers, carbon nanotubes or glass fibers embedded in a thermoplastic matrix) used in thermoplastic composite pipes with a structure similar to those described in DNV-RP-F119.

In some embodiments, the flexible pipe can be a flexible underwater pipe.

In some embodiments, a flexible pipe can include an outer sheath including the TPV composition and/or PMP composition that is extruded onto an outer armor layer or onto an insulation layer of the unbonded flexible pipe. In some embodiments, the TPV composition and/or PMP composition can be extruded as an outer sheath layer having a thickness of from about 2 mm to about 30 mm.

In some embodiments, the TPV composition and/or PMP composition can be a thermal insulating layer. The TPV composition and/or PMP composition can possess one or more highly advantageous properties such as low density, low thermal conductivity, high gas permeability, and stable thermal conductivity over time. The thermal insulation layer can have a thickness in the range from about 2 mm to about 30 mm. In some embodiments, the TPV composition and/or PMP composition can be applied as a wound insulation layer, such as a layer wound from one or more tapes. The tapes can be extruded with any thickness, but in order to obtain an even surface the tapes can possess a thickness of up to about 10 mm, such as from about 0.1 to about 5 mm.

In some embodiments, the TPV composition and/or PMP composition can be an intermediate sheath between armor layers of the flexible pipe whereby the TPV-based layer and/or PMP-based layer can protect the armor layers from abrasion damage as a wear layer. In some embodiments, a flexible pipe can include an intermediate sheath having a thickness of from 1 mm to 10 mm.

In some embodiments, a flexible pipe includes an inner pressure sheath; an inner housing or carcass; at least one armor layer (or reinforcing layer) at least partially disposed around the inner housing; and an outer sheath at least partially disposed around the at least one reinforcing layer.

In some embodiments, a flexible pipe can include a) an inner pressure sheath for confining the fluid to be transported by the pipe, b) at least one armoring layer (or reinforcing layer) at least partially disposed around the inner pressure sheath, c) at least one intermediate layer at least partially disposed around the at least one armoring layer, d) at least one outer sheath at least partially disposed around the at least one intermediate layer and/or at least one armoring layer.

Although the TPV compositions and/or PMP compositions will be described as included in an outer sheath of a flexible pipe, it should be understood that the TPV compositions and/or PMP compositions can, instead, be or additionally be included in other layers, e.g., an intermediate sheath, of a flexible pipe.

The pipes of the present disclosure can be used for offshore and onshore applications, such as for the transporting of fluids.

Although the TPV compositions and/or PMP compositions will be described as included in a flexible pipe, it should be understood that the TPV compositions and/or PMP compositions can be included in one or more layers of a rigid pipe.

While the specification is described in embodiments of a flexible pipe, it should be understood that the specification is applicable to umbilicals, thermoplastic composite pipes, and thermoplastic hoses, flow lines, wet insulated pipes and the like.

In some embodiments, an article includes a thermal insulation layer, the thermal insulation layer including a TPV composition described herein. The article can further include a battery, such as an electric vehicle car battery, an electronic (such as a consumer electronic), a heater, or the like, or a combination thereof.

### Example Formulations of the TPV Compositions

In some embodiments, the TPV composition can include an amount of a rubber such as ethylene propylene terpolymer rubber (such as EPDM rubber), butyl rubber, halobutyl, halogenated copolymer of a C₄ to C₇ isomonoolefin and a paraalkylstyrene, or a combination thereof, that is about 80 wt % or less of rubber, about 50 wt % or less of rubber, such as about 40 wt % or less of rubber, such as about 30 wt % or less based on a combined weight of the rubber and the thermoplastic polyolefin. In these or other embodiments, the amount of rubber within the TPV composition can be from about 10 wt % to about 80 wt %, such as from about 10 wt % to about 30 wt %, such as from about 12 wt % to about 25 wt %, such as from about 14 wt % to about 24 wt %, based on a combined weight of the rubber and the thermoplastic polyolefin. The rubber can be in a crosslinked or partially crosslinked form in the TPV composition.

In these and other embodiments, the TPV composition can include an amount of a thermoplastic phase (e.g., a thermoplastic polymer or a thermoplastic polyolefin) that is from about 20 wt % to about 90 wt %, such as from about 30 wt % to about 90 wt %, such as from about 50 wt % to about 90 wt %, such as from about 60 wt % to about 90 wt %, based on a combined weight of the rubber and the thermoplastic polyolefin. In some embodiments, the concentration of the thermoplastic polyolefin in the TPV composition is from about 20 wt % to about 80 wt %, such as from about 25 wt % to about 75 wt %, such as from about 27 wt % to about 70 wt %, such as from about 30 wt % to about 70 wt % based on the combined weight of the rubber and the thermoplastic polyolefin.

In some embodiments, where the thermoplastic phase can include more than one type of thermoplastic polyolefin, the thermoplastic phase can include from about 51 wt % to about 100 wt % of one type of thermoplastic polyolefin, such as from about 65 wt % to about 99.5 wt %, such as from about 85 wt % to about 99 wt %, such as from about 95 wt % to about 98 wt %, based on a total weight of the thermoplastic phase, with balance of the thermoplastic phase including one or more different types of thermoplastic polyolefin. For example, and in some embodiments, the thermoplastic phase can include from about 0 wt % to about 49 wt % of a second type of thermoplastic polyolefin, such as from about 1 wt % to about 15 wt %, such as from about 2 wt % to about 5 wt %, based on the total weight of the thermoplastic phase.

In some embodiments, fillers (such as calcium carbonate, clays, silica, talc, titanium dioxide, carbon black, a nucleating agent, mica, wood flour, and the like, and blends thereof, as well as inorganic and organic nanoscopic fillers) can be present in the TPV composition in an amount from about 0.1 wt % to about 10 wt %, such as from about 1 wt % to about 7 wt %, such as from about 2 wt % to about 5 wt %, based on the total weight of the TPV composition. The amount of filler that can be used can depend, at least in part, upon the type of filler and the amount of extender oil that is used.

In some embodiments, an oil (e.g., an extender oil) can be present in the TPV composition in an amount from about 10 wt % to about 40 wt %, such as from about 12 wt % to about 35 wt %, such as from about 14 wt % to about 32 wt % based on the total weight of the TPV composition. The quantity of oil added can depend on the properties desired, with an upper limit that can depend on the compatibility of the particular oil and blend ingredients; and this limit can be exceeded when excessive exuding of oil occurs. The amount of oil can depend, at least in part, upon the type of rubber. High viscosity rubbers are more highly oil extendable. Where low molecular weight ester plasticizers are employed, the ester plasticizers can be used in amounts of about 40 wt % or less, such as about 35 wt % or less, based on the total weight of the TPV composition.

In some embodiments, the TPV composition can include a curative. Amounts and types of curatives that are useful for the TPV compositions described herein are discussed below.

In some embodiments, and when employed, the TPV composition can include a processing additive (e.g., a polymeric processing additive) in an amount of from about 0.1 wt % to about 20 wt % based on the total weight of the TPV composition.

In some embodiments, the TPV composition can optionally include reinforcing and non-reinforcing fillers, colorants, antioxidants, nucleators, stabilizers, rubber processing oil, lubricants, antiblocking agents, anti-static agents, waxes, foaming agents, pigments, flame retardants, antistatic agents, slip master batches, siloxane based slip agents (e.g., Dow Corning™ HMB-0221 Masterbatch available from Dow Chemical Company) ultraviolet inhibitors, antioxidants, and other processing aids known in the rubber and TPV compounding art. These additives can be used in the TPV compositions at an amount up to about 20 wt % of the total weight of the TPV composition.

### Thermoplastic Phase

In some embodiments, one or more polymethylpentene (PMP) thermoplastic polymers can be used to form one or more layers of the pipe. In some embodiments, the PMP described in this section can be used alone as one or more layers of a pipe. In some embodiments, the PMP described in this section can be used as part of a TPV composition.

In some embodiments, a thermoplastic phase of a TPV composition useful in one or more layers of flexible pipes can include a polymer that can flow above its melting temperature. In some embodiments, a major component (or sole component) of the thermoplastic phase can include at least one thermoplastic polyolefin such as a PMP (such as a homopolymer, random copolymer, or impact copolymer, or combination thereof) and/or a propylene-based polymer (such as a homopolymer, random copolymer, or impact copolymer, or combination thereof). In some embodiments, a minor component of the thermoplastic phase can include at least one thermoplastic polyolefin such as a PMP (such as a homopolymer, random copolymer, or impact copolymer, or combination thereof) and/or a propylene-based polymer (such as a homopolymer, random copolymer, or impact copolymer, or combination thereof). PMP can be formed from units of 4-methyl-1-pentene.

### 1. Polymethylpentene (PMP)

PMP includes those solid, generally high molecular weight plastic resins that primarily include units deriving from the polymerization of 4-methyl-1-pentene. In some embodiments, at least 75%, or at least 90%, or at least 95%, or at least 97% of the units of a polymethylpentene can derive from the polymerization of 4-methyl-1-pentene. In particular embodiments, these polymers include homopolymers of 4-methyl-1-pentene. Homopolymer 4-methyl-1-pentene can include linear chains and/or chains with long chain branching.

In some embodiments, the PMP-based polymers can include units deriving from the polymerization of ethylene and/or α-olefins such as propylene, 1-butene, 1-hexene, 1-octene, 1-decene, 1-tetradecene, 1-octadecene, 2-methyl-1-propene, 5-methyl-1-hexene, and mixtures thereof. Specifically included are the reactor, impact, and random copolymers of propylene with ethylene or the higher α-olefins, such as with C₂-C₄₀ α-olefins, such as C₃-C₂₀ α-olefins, such as C₄-C₁₀ α-olefins.

The polymethylpentene, a product originating from the polymerization of 4-methyl-1-pentene, can also be in homopolymeric or in copolymeric form. This polymerization can be done with the use of a Ziegler-Natta catalyst, resulting in highly regular, partially crystalline polymers with a high melting point (above about 220° C.). Commercially available copolymeric polymethylpentene is made by a copolymerization of 4-methyl-1-pentene with linear α-olefins having 6-16 C-atoms, like 1-pentene, 1-hexene, 1-octene, 1-decene. Reference can be had to the Encyclopedia of Polymer Science and Engineering, v. 9, pages 707-718, 1987, which is incorporated by reference herein.

In some embodiments, the PMP-based polymer can include one or more of the following characteristics:

1) The PMP-based polymers can have a melt mass flow rate (MFR) (ASTM D1238-70, 5 kg weight @ 260° C.) of about 0.5 g/10 min or more, such as about 5 g/10 min or more, such as about 100 g/10 min or more. Alternatively, the MFR can be from about 0.5 g/10 min to about 250 g/10 min, such as from about 5 g/10 min to about 200 g/10 min, such as from about 50 g/10 min to about 100 g/10 min.

2) The PMP-based polymers can have about 50 wt % or less of units derived from an alpha-olefin monomer, such as 45 wt % or less, such as 40 wt % or less, such as 35 wt % or less, such as 30 wt % or less, such as 25 wt % or less, such as 20 wt % or less, such as 15 wt % or less, such as 10 wt % or less, such as 5 wt % or less, such as 0 wt %.

3) The PMP-based polymers can have a Young's Modulus (ISO 527, 23° C., 1 mm/min) of from about 100 MPa to about 2,000 MPa, such as from about 125 to about 1,700 MPa, such as from about 150 MPa to about 1,600 MPa, such as from about 250 to about 1,500 MPa, such as from about 350 MPa to about 1,500 MPa. In at least one embodiment, the Young's Modulus can be from about 100 MPa to about 1,700 MPa, or from about 300 MPa to about 1,600 MPa, or from about 400 MPa to about 1,500 MPa.

4) The PMP-based polymers can have a density (as measured by ASTM D792) of from about 0.800 to about 0.910, such as from about 0.810 to about 0.900, such as from about 0.820 to about 0.880.

5) The PMP-based polymers can have a melt temperature (Tm) of from about 180° C. to about 270° C., such as from about 200° C. to about 250° C., such as from about 215° C. to about 250° C., as measured by ASTM D3418.

6) The PMP-based polymers can have a melt index (ASTM D1238-70, 5 kg weight @ 260° C.) of about 1 g/10 min to about 100 g/10 min, such as from about 5 g/10 min to about 80 g/10 min, such as from about 5 g/10 min to about 80 g/10 min, such as from about 10 g/10 min to about 70 g/10 min, such as from about 20 g/10 min to about 60 g/10 min, such as from about 30 g/10 min to about 60 g/10 min.

In some embodiments, the PMP includes a homopolymer, random copolymer, or impact copolymer PMP or combination thereof. In some embodiments, the PMP is a high melt strength (HMS) long chain branched (LCB) homopolymer PMP.

The PMP-based polymers can be synthesized by using an appropriate polymerization technique known in the art such as the conventional Ziegler-Natta type polymerizations, and catalysis employing single-site organometallic catalysts including metallocene catalysts.

Examples of PMP resins useful for embodiments described herein include TPX™ RT18, TPX™ MX002, and TPX™ MX004 (available from Mitsui).

### 2. Propylene-Based Polymer

Propylene-based polymers include those solid, generally high molecular weight plastic resins that primarily include units deriving from the polymerization of propylene. In some embodiments at least 75%, in other embodiments at least 90%, in other embodiments at least 95%, and in other embodiments at least 97% of the units of the propylene-based polymer can derive from the polymerization of propylene. In particular embodiments, these polymers include homopolymers of propylene. Homopolymer polypropylene can include linear chains and/or chains with long chain branching.

In some embodiments, the propylene-based polymers can include units deriving from the polymerization of ethylene and/or α-olefins such as 1-butene, 1-hexene, 1-octene, 2-methyl-1-propene, 3-methyl-1-pentene, 4-methyl-1-pentene, 5-methyl-1-hexene, and mixtures thereof. Specifically included are the reactor, impact, and random copolymers of propylene with ethylene or the higher α-olefins, such as with C₄-C₄₀ α-olefins, such as C₅-C₂₀ α-olefins, such as C₆-C₁₀ α-olefins.

In some embodiments, the propylene-based polymer can include one or more of the following characteristics:

1) The propylene-based polymers can include semi-crystalline polymers. In some embodiments, these polymers can be characterized by a crystallinity of at least about 25 wt % or more, such as about 55 wt % or more, such as about 65 wt % or more, such as about 70 wt % or more. Crystallinity can be determined by dividing the heat of fusion (Hf) of a sample by the heat of fusion of a 100% crystalline polymer, which is assumed to be 209 joules/gram for polypropylene.

2) The propylene-based polymers can have a Hf that of about 52.3 J/g or more, such as about 100 J/g or more, such as about 125 J/g or more, such as about 140 J/g or more, as measured by ASTM D3418.

3) The propylene-based polymers can have a weight average molecular weight (Mw) of from about 50,000 g/mol to about 2,000,000 g/mol, such as from about 100,000 g/mol to about 1,000,000 g/mol, such as from about 100,000 g/mol to about 600,000 g/mol or from about 400,000 g/mol to about 800,000 g/mol, as measured by GPC with polystyrene standards.

4) The propylene-based polymers can have a number average molecular weight (Mn) of from about 25,000 g/mol to about 1,000,000 g/mol, such as from about 50,000 g/mol to about 300,000 g/mol, as measured by GPC with polystyrene standards.

5) The propylene-based polymers can have a g′μs that of about 1 or less, such as about 0.9 or less, such as about 0.8 or less, such as about 0.6 or less, such as about 0.5 or less, as measured by GPC procedure described below.

6) The propylene-based polymers can have a melt mass flow rate (MFR) (ASTM D1238, 2.16 kg weight @ 230° C.) of about 0.1 g/10 min or more, such as about 0.2 g/10 min or more, such as about 0.25 g/10 min or more. Alternatively, the MFR can be from about 0.1 g/10 min to about 50 g/10 min, such as from about 0.5 g/10 min to about 5 g/10 min, such as from about 0.5 g/10 min to about 3 g/10 min.

7) The propylene-based polymers can have a melt temperature (Tm) of from about 110° C. to about 170° C., such as from about 140° C. to about 168° C., such as from about 160° C. to about 165° C., as measured by ASTM D3418.

8) The propylene-based polymers can have a glass transition temperature (T_{g}) of from about −50° C. to about 10° C., such as from about −30° C. to about 5° C., such as from about −20° C. to about 2° C., as measured by ASTM D3418.

9) The propylene-based polymers can have a crystallization temperature (Tc) of about 75° C. or more, such as about 95° C. or more, such as about 100° C. or more, such as about 105° C. or more, such as from about 105° C. to about 130° C., as measured by ASTM D3418.

In some embodiments, the propylene-based polymers can include a homopolymer of a high-crystallinity isotactic or syndiotactic polypropylene. This polypropylene can have a density of from about 0.89 to about 0.91 g/ml, with the largely isotactic polypropylene having a density of from about 0.90 to about 0.91 g/ml. Also, high and ultra-high molecular weight polypropylene that has a fractional melt flow rate can be employed. In some embodiments, polypropylene resins can be characterized by a MFR (ASTM D-1238; 2.16 kg @ 230° C.) that can be about 10 dg/min or less, such as about 1.0 dg/min or less, such as about 0.5 dg/min or less.

In some embodiments, the polypropylene includes a homopolymer, random copolymer, or impact copolymer polypropylene or combination thereof. In some embodiments, the polypropylene is a high melt strength (HMS) long chain branched (LCB) homopolymer polypropylene.

The propylene-based polymers can be synthesized by using an appropriate polymerization technique known in the art such as the conventional Ziegler-Natta type polymerizations, and catalysis employing single-site organometallic catalysts including metallocene catalysts.

Examples of polypropylene useful for the TPV compositions described herein include ExxonMobil™ PP5341 (available from ExxonMobil); Achieve™ PP6282NE1 (available from ExxonMobil) and/or polypropylene resins with broad molecular weight distribution as described in U.S. Pat. Nos. 9,453,093 and 9,464,178; and other polypropylene resins described in US 2018/0016414 and US 2018/0051160; Waymax MFX6 (available from Japan Polypropylene Corp.); Borealis Daploy™ WB140 (available from Borealis AG); and Braskem Ampleo 1025MA and Braskem Ampleo 1020GA (available from Braskem Ampleo), and other suitable polypropylenes.

In one or more embodiments, the thermoplastic component can include isotactic polypropylene. In some embodiments, the thermoplastic component can contain one or more crystalline propylene homopolymers or copolymers of propylene having a melting temperature of from about 110° C. to about 170° C. or higher as measured by DSC. Example copolymers of propylene can include terpolymers of propylene, impact copolymers of propylene, random polypropylene and mixtures thereof. Example comonomers can have about 2 carbon atoms or from about 4 to about 12 carbon atoms. In some embodiments, the comonomer can be ethylene.

The term “random polypropylene” as used herein broadly means a single phase copolymer of propylene having up to about 9 wt %, such as from about 2 wt % to about 8 wt % of an alpha olefin comonomer. Example alpha olefin comonomers can have about 2 carbon atoms or from about 4 to about 12 carbon atoms. In some embodiments, the alpha olefin comonomer can be ethylene.

In one or more embodiments, the thermoplastic resin component can be or include a “propylene-based copolymer.” A “propylene-based copolymer” includes at least two different types of monomer units, one of which is propylene. Suitable monomer units can include ethylene and higher alpha-olefins ranging from C₄ to C₂₀, such as, for example, 1-butene, 4-methyl-1-pentene, 1-hexene, 1-octene, 1-decene, or mixtures thereof. In some embodiments, ethylene can be copolymerized with propylene, so that the propylene-based copolymer includes propylene-derived units (units on the polymer chain derived from propylene monomers) and ethylene-derived units (units on the polymer chain derived from ethylene monomers).

### Rubber Phase

Rubbers that can be employed to form the rubber phase can include those polymers that are capable of being cured or crosslinked by, e.g., a phenolic resin, a hydrosilylation curative (e.g., silane-containing curative), a peroxide with a coagent, a moisture cure via silane grafting, or an azide. Reference to a rubber can include mixtures of more than one rubber. Non-limiting examples of rubbers can include olefinic elastomeric terpolymers, butyl rubbers (such as isobutylene-isoprene rubber (IIR), brominated isobutylene-isoprene rubber (BIIR), isobutylene paramethylstyrene rubber (BIMSM), and halogenated copolymer of a C₄ to C₇ isomonoolefin and a paraalkylstyrene), and combinations and mixtures thereof. In some embodiments, olefinic elastomeric terpolymers can include ethylene-based elastomers such as ethylene-propylene-non-conjugated diene rubbers.

### 1. Ethylene-Propylene Rubber

The term ethylene-propylene rubber refers to rubbery terpolymers polymerized from ethylene, at least one other α-olefin monomer, and at least one diene monomer (for example, an ethylene-propylene-diene terpolymer or an EPDM terpolymer). The α-olefin monomer can include propylene, 1-butene, 1-hexene, 4-methyl-1-pentene, 1-octene, 1-decene, or a combination thereof. In at least one embodiment, the α-olefins can include propylene, 1-hexene, 1-octene or a combination thereof. The diene monomers can include 5-ethylidene-2-norbornene (ENB); 5-vinyl-2-norbornene (VNB); divinylbenzene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; dicyclopentadiene; or a combination thereof. Polymers prepared from ethylene, α-olefin monomer, and diene monomer can be referred to as a terpolymer or even a tetrapolymer in the event that multiple α-olefin monomers or diene monomers are used.

In some embodiments, where the diene monomer includes 5-ethylidene norbornene (ENB) or 5-vinyl-2-norbornene (VNB), the ethylene-propylene rubber can include at least about 1 wt % of diene monomer, such as at least about 3 wt %, such as at least about 4 wt %, such as at least about 5 wt %, such as at least about 10 wt %, based on the total weight of an ethylene-propylene rubber. In other embodiments, where the diene includes ENB or VNB, the ethylene-propylene rubber can include from about 1 wt % to about 15 wt % of diene monomer, such as from about 3 wt % to about 15 wt %, such as from about 5 wt % to about 12 wt %, such as from about 7 wt % to about 11 wt %, based on the total weight of the ethylene-propylene rubber.

In some embodiments, the ethylene-propylene rubber can include one or more of the following:

1) An ethylene-derived content that can be from about 10 wt % to about 99.9 wt %, such as from about 10 wt % to about 90 wt %, such as from about 12 wt % to about 90 wt %, such as from about 15 wt % to about 90 wt %, such as from about 20 wt % to about 80 wt %, such as from about 40 wt % to about 70 wt %, such as from about 45 wt % to about 65 wt %, based on the total weight of the ethylene-propylene rubber. In some embodiments, the ethylene-derived content can be from about 40 wt % to about 85 wt %, such as from about 40 wt % to about 85 wt % based on the total weight of the ethylene-propylene rubber.

2) A diene-derived content that can be from about 0.1 to about to about 15 wt %, such as from about 0.1 wt % to about 5 wt %, such as from about 0.2 wt % to about 10 wt %, such as from about 2 wt % to about 8 wt %, or from about 4 wt % to about 12 wt %, such as from about 4 wt % to about 9 wt % based on the total weight of the ethylene-propylene rubber. In some embodiments, the diene-derived content can be from about 3 wt % to about 15 wt % based on the total weight of the ethylene-propylene rubber.

3) The balance of the ethylene-propylene rubber can be α-olefin-derived content, e.g., C₂ to C₄₀, such as C₃ to C₂₀, such as C₃ to C₁₀ olefins, such as propylene.

4) A weight average molecular weight (Mw) that can be about 100,000 g/mol or more, such as about 200,000 g/mol or more, such as about 400,000 g/mol or more, such as about 600,000 g/mol or more. In these or other embodiments, the Mw is about 1,200,000 g/mol or less, such as about 1,000,000 g/mol or less, such as about 900,000 g/mol or less, such as about 800,000 g/mol or less. In these or other embodiments, the Mw can be from about 400,000 g/mol to about 3,000,000 g/mol, such as from about 400,000 g/mol to about 2,000,000, such as from about 500,000 g/mol to about 1,500,000 g/mol, such as from about 600,000 g/mol to about 1,200,000 g/mol, such as from about 600,000 g/mol to about 1,000,000 g/mol. Mw is measured according to GPC with polystyrene standards.

5) A number average molecular weight (Mn) that can be about 20,000 g/mol or more (such as about 60,000 g/mol or more, such as about 100,000 g/mol or more, such as about 150,000 g/mol or more. In these or other embodiments, the Mn can be less than about 500,000 g/mol, such as about 400,000 g/mol or less, such as about 300,000 g/mol or less, such as about 250,000 g/mol or less. Mn is measured according to GPC with polystyrene standards.

6) A Z-average molecular weight (Mz) that can be from about 10,000 g/mol to about 7,000,000 g/mol, such as from about 50,000 g/mol to about 3,000,000 g/mol, such as from about 70,000 g/mol to about 2,000,000 g/mol, such as from about 75,000 g/mol to about 1,500,000 g/mol, such as from about 80,000 g/mol to about 700,000 g/mol, such as from about 100,000 g/mol to about 500,000 g/mol. Mz is measured according to GPC with polystyrene standards.

7) A polydispersity index (Mw/Mn; PDI) that can be from about 1 to about 10, such as from about 1 to about 5, such as from about 1 to about 4, such as from about 2 to about 4 or from about 1 to about 3, such as from about 1.8 to about 3 or from about 1 to about 2, or from about 1 to about 2.5, as measured by GPC with polystyrene standards.

8) A dry Mooney viscosity (ML₍₁₊₄₎ at 125° C.) per ASTM D-1646, that can be from about 10 MU to about 500 MU or from about 50 MU to about 450 MU. In these or other embodiments, the Mooney viscosity can be about 250 MU or more, such as 350 MU or more, such as 450 MU or less.

9) A glass transition temperature (T_{g}), as determined by Differential Scanning calorimetry (DSC) according to ASTM E 1356, that can be about −20° C. or less, such as about −30° C. or less, such as about −50° C. or less. In some embodiments, T_{g} can be from about −20° C. to about −60° C.

The ethylene-propylene rubber can be manufactured or synthesized by using a variety of techniques. For example, these terpolymers can be synthesized by employing solution, slurry, or gas phase polymerization techniques or a combination thereof that employ various catalyst systems including Ziegler-Natta systems including vanadium catalysts and take place in various phases such as solution, slurry, or gas phase. Example catalysts can include single-site catalysts including constrained geometry catalysts involving Group IV-VI metallocenes. In some embodiments, the EPDMs can be produced via a conventional Zeigler-Natta catalyst using a slurry process, especially those including Vanadium compounds, as disclosed in U.S. Pat. No. 5,783,645, as well as metallocene catalysts, which are also disclosed in U.S. Pat. No. 5,756,416 each of which is incorporated herein by reference in their entirety. Other catalysts systems such as the Brookhart catalyst system can also be employed. Optionally, such EPDMs can be prepared using the above catalyst systems in a solution process.

Some elastomeric terpolymers are commercially available under the tradenames Vistalon™ (ExxonMobil Chemical Co.; Houston, Tex.), Keltan™ (Arlanxeo Performance Elastomers; Orange, Tex.), Nordel™ IP (Dow), NORDEL MG™ (Dow), Royalene™ (Lion Elastomers), KEP (Kumho Polychem), and Suprene™ (SK Global Chemical). Specific examples include Vistalon 3666, Vistalon 9600, Keltan 9950C, Keltan 8550C, KEP 8512, KEP 9590, Keltan 5469 Q, Keltan 4969 Q, Keltan 5469 C, and Keltan 4869 C, Royalene 694, Royalene 677, Suprene 512F, Nordel 6555, Nordel 4571XFM, Royalene 515.

In some embodiments, the ethylene propylene rubber can be obtained in an oil extended form, with about a 50 phr to about 200 phr process oil, such as about 75 phr to about 120 phr process oil on the basis of 100 phr of rubber.

### 2. Butyl Rubber

In some embodiments, butyl rubber can include copolymers and terpolymers of isobutylene and at least one other comonomer. Useful comonomers can include isoprene, divinyl aromatic monomers, alkyl substituted vinyl aromatic monomers, and mixtures thereof. Example divinyl aromatic monomers can include vinylstyrene. Example alkyl substituted vinyl aromatic monomers can include α-methylstyrene and paramethylstyrene. These copolymers and terpolymers can be halogenated butyl rubbers (also known as halobutyl rubbers) such as in the case of chlorinated butyl rubber and brominated butyl rubber. In some embodiments, these halogenated polymers can derive from monomer such as parabromomethylstyrene.

In some embodiments, butyl rubber can include copolymers of isobutylene and isoprene, and copolymers of isobutylene and paramethyl styrene, terpolymers of isobutylene, isoprene, and vinylstyrene, branched butyl rubber, and brominated copolymers of isobutene and paramethylstyrene (yielding copolymers with parabromomethylstyrenyl mer units). These copolymers and terpolymers can be halogenated. Example butyl rubbers can include isobutylene-isoprene rubber (IIR), brominated isobutylene-isoprene rubber (BIIR), chlorinated isobutylene-isoprene rubber (CIIR), isobutylene paramethyl styrene rubber (BIMSM), halogenated copolymer of a C₄ to C₇ isomonoolefin and a paraalkylstyrene, or a combination thereof.

In some embodiments, the butyl rubber can include one or more of the following characteristics:

1) Where butyl rubber includes the isobutylene-isoprene rubber, the rubber can include isoprene in an amount from about 0.5 wt % to about 30 wt %, such as from about 0.8 wt % to about 5 wt %, based on the entire weight of the rubber with the remainder being isobutylene.

2) Where butyl rubber includes isobutylene-paramethylstyrene rubber, the rubber can include paramethylstyrene in an amount from about 0.5 wt % to about 25 wt %, such as from about 2 wt % to about 20 wt %, based on the entire weight of the rubber with the remainder being isobutylene.

3) Where the isobutylene-paramethylstyrene rubbers are halogenated, such as with bromine and/or chlorine, these halogenated rubbers can have a percent by weight halogenation of from about 0 wt % to about 10 wt %, such as from about 0.3 wt % to about 7 wt %, based on the entire weight of the rubber with the remainder being isobutylene.

4) Where the isobutylene-isoprene rubbers are halogenated, such as with bromine and/or chlorine, these halogenated rubbers can have a percent by weight halogenation of from about 0 wt % to about 10 wt %, such as from about 0.3 wt % to about 7 wt %, based on the entire weight of the rubber with the remainder being isobutylene.

5) Where butyl rubber includes isobutylene-isoprene-divinylbenzene, the butyl rubber can include isobutylene in an amount from about 95 wt % to about 99 wt %, such as from about 96 wt % to about 98.5 wt %, based on the entire weight of the rubber, and isoprene from about 0.5 wt % to about 5 wt %, such as from about 0.8 wt % to about 2.5 wt %, based on the entire weight of the rubber, with the balance being divinylbenzene.

6) Where the butyl rubber includes halogenated butyl rubbers, the butyl rubber can include from about 0.1 wt % to about 10 wt % halogen, such as from about 0.3 wt % to about 7 wt %, such as from about 0.5 wt % to about 3 wt %, based on the entire weight of the rubber.

8) A weight average molecular weight (Mw) that can be about 100,000 g/mol or more, such as about 200,000 g/mol or more, such as about 400,000 g/mol or more, such as about 600,000 g/mol or more). In these or other embodiments, the Mw can be about 1,200,000 g/mol or less, such as about 1,000,000 g/mol or less, such as about 900,000 g/mol or less, such as about 800,000 g/mol or less). In these or other embodiments, the Mw can be from about 500,000 g/mol to about 3,000,000 g/mol, such as from about 500,000 g/mol to about 2,000,000, such as from about 500,000 g/mol to about 1,500,000 g/mol, such as from about 600,000 g/mol to about 1,200,000 g/mol, such as from about 600,000 g/mol to about 1,000,000 g/mol. Mw is measured according to GPC with polystyrene standards.

Butyl rubber can be obtained from a number of commercial sources as disclosed in the Rubber World Blue Book. For example, both halogenated and un-halogenated rubbers/copolymers of isobutylene and isoprene are available under the tradename Exxon Butyl™ (ExxonMobil Chemical Co.), halogenated and un-halogenated copolymers of isobutylene and paramethylstyrene are available under the tradename EXXPRO™ (ExxonMobil Chemical Co.), star branched butyl rubbers are available under the tradename STAR BRANCHED BUTYL™ (ExxonMobil Chemical Co.), and copolymers having parabromomethylstyrenyl mer units are available under the tradename EXXPRO 3745 (ExxonMobil Chemical Co.). Halogenated and non-halogenated terpolymers of isobutylene, isoprene, and divinylstyrene are available under the tradename Polysar Butyl™ (Lanxess; Germany).

In some embodiments, the rubber (e.g., ethylene-propylene rubber or butyl rubber) can be highly cured. In some embodiments, the rubber can be partially or fully (completely) cured. The degree of cure can be measured by determining the amount of rubber that is extractable from the TPV composition by using cyclohexane or boiling xylene as an extractant. This method is disclosed in U.S. Pat. No. 4,311,628, which is incorporated herein by reference for purposes of U.S. patent practice. In some embodiments, the rubber can have a degree of cure where not more than about 5.9 wt %, such as not more than about 5 wt %, such as not more than about 4 wt %, such as not more than about 3 wt % is extractable by cyclohexane at 23° C. as described in U.S. Pat. Nos. 5,100,947 and 5,157,081, which are incorporated herein by reference for purpose of U.S. patent practice. In these or other embodiments, the rubber is cured to an extent where greater than about 94 wt %, such as greater than about 95 wt %, such as greater than about 96 wt %, such as greater than about 97 wt % by weight of the rubber is insoluble in cyclohexane at 23° C. Alternatively, in some embodiments, the rubber can have a degree of cure such that the crosslink density can be at least about 4×10⁻⁵ moles per milliliter of rubber, such as at least about 7×10⁻⁵ moles per milliliter of rubber, such as at least about 10×10⁻⁵ moles per milliliter of rubber. See also “Crosslink Densities and Phase Morphologies in Dynamically Vulcanized TPEs,” by Ellul et al., Rubber Chemistry And Technology, v. 68, pp. 573-584 (1995), which is incorporated by reference herein in its entirety.

Despite the fact that the rubber can be partially or fully cured, the compositions of this disclosure can be processed and reprocessed by conventional plastic processing techniques such as extrusion, injection molding, blow molding, and compression molding. The rubber within these thermoplastic elastomers can be in the form of finely-divided and well-dispersed particles of vulcanized or cured rubber within a continuous thermoplastic phase or matrix. In some embodiments, a co-continuous morphology or a phase inversion can be achieved. In those embodiments where the cured rubber is in the form of finely-divided and well-dispersed particles within the thermoplastic medium, the rubber particles can have an average diameter that is about 50 μm or less (such as about 30 μm or less, such as about 10 μm or less, such as about 5 μm or less, such as about 1 μm or less). In some embodiments, at least about 50% of the particles, such as about 60% of the particles, such as about 75% of the particles can have an average diameter of about 5 μm or less, such as about 2 μm or less, such as about 1 μm or less.

### Other Constituents of the PMP Compositions and TPV Compositions

In some embodiments, the PMP compositions and/or TPV compositions useful in one or more layers of a flexible pipe or article can include a polymeric processing additive. The processing additive can be a polymeric resin that has a very high melt flow index. These polymeric resins can include both linear and branched polymers that have a melt flow rate that is about 500 dg/min or more, such as about 750 dg/min or more, such as about 1,000 dg/min or more, such as about 1,200 dg/min or more, such as about 1,500 dg/min or more. Mixtures of various branched or various linear polymeric processing additives, as well as mixtures of both linear and branched polymeric processing additives, can be employed. Reference to polymeric processing additives can include both linear and branched additives unless otherwise specified. Linear polymeric processing additives can include polypropylene homopolymers, and branched polymeric processing additives include diene-modified polypropylene polymers. TPV compositions that include similar processing additives are disclosed in U.S. Pat. No. 6,451,915, which is incorporated herein by reference for purpose of U.S. patent practice.

Additives can be added to the PMP compositions and/or TPV compositions of the present disclosure. These additives can include thermal stabilizers and UV stabilizers.

Fillers and extenders that can be utilized for the PMP compositions and/or TPV compositions include conventional inorganics such as calcium carbonate, clays, silica, talc, titanium dioxide, carbon black, a nucleating agent, mica, wood flour, and the like, and blends thereof, as well as inorganic and organic nanoscopic fillers.

### Nucleating Agent

The term “nucleating agent” means any additive that produces a nucleation site for thermoplastic crystals to grow from a molten state to a solid, cooled structure. In other words, nucleating agents provide sites for growing thermoplastic crystals upon cooling the thermoplastic from its molten state.

The nucleating agent can provide a plurality of nucleating sites for the thermoplastic component to crystallize when cooled. The plurality of nucleating sites promotes even crystallization within the thermoplastic vulcanizate composition, allowing the composition to crystallize throughout an entire cross section in less time and at higher temperature. This plurality of nucleating site produces a greater amount of smaller crystals within the thermoplastic vulcanizate composition which require less cooling time.

This even cooling distribution can enable the formation of extruded articles of the present PMP compositions and/or TPV compositions having a thickness greater than 2 mm, such as greater than 5 mm, greater than 10 mm, or even greater than 15 mm. Extruded articles of the present PMP compositions and/or TPV compositions can have thicknesses greater than 20 mm and still exhibit effective cooling (e.g., cooling from an outer surface of the cross section to an inner surface of the cross section) at extrusion temperatures without sacrificing mechanical strength. Such extrusion temperatures can be at or above the melting point of the thermoplastic component. Illustrative nucleating agents can include dibenzylidene sorbitol based compounds, sodium benzoate, sodium phosphate salts, as well as lithium phosphate salts. For example, the nucleating agent can include sodium 2,2′-methylene-bis-(2,6-di-tert-butylphenyl)phosphate which is commercially available from Milliken & Company of Spartanburg, S.C. under the trade name Hyperform™. Another specific nucleating agent can be norbornane (bicyclo(2.2.1)heptane carboxylic acid salt, which is commercially available from CIBA Specialty Chemicals of Basel, Switzerland.

### Processing Oils/Plasticizers

In some embodiments, the PMP compositions and/or TPV compositions can include a plasticizer such as an oil, such as a mineral oil, a synthetic oil, or a combination thereof. These oils can also be referred to as plasticizers or extenders. Mineral oils can include aromatic, naphthenic, paraffinic, and isoparaffinic oils, synthetic oils, and a combination thereof. In some embodiments, the mineral oils can be treated or untreated. Useful mineral oils can be obtained under the tradename SUNPAR™ (Sun Chemicals), such as SUNPAR™ 115, and SUNPAR™ 150. Other oils are available under the tradename PARALUX™ (Chevron), and PARAMOUNT™ (Chevron), such as PARAMOUNT 6001R™. Other oils that can be used include hydrocarbon oils and plasticizers, such as synthetic plasticizers. Many additive oils are derived from petroleum fractions, and have particular ASTM designations depending on whether they fall into the class of paraffinic, naphthenic, or aromatic oils. Other types of additive oils can include alpha olefinic synthetic oils, such as liquid polybutylene and polyisobutylene. Additive oils other than petroleum based oils can be used, such as oils derived from coal tar and pine tar, as well as synthetic oils, e.g., polyolefin materials. Other plasticizers can include triisononyl trimellitate (TINTM). In addition, vegetable or animal oils can be also used as plasticizer and/or processing aid in the PMP compositions and/or TPV compositions.

Examples of oils can include base stocks. According to the American Petroleum Institute (API) classifications, base stocks are categorized in five groups based on their saturated hydrocarbon content, sulfur level, and viscosity index (Table 1). Lube base stocks are typically produced in large scale from non-renewable petroleum sources. Group I, II, and III base stocks are all derived from crude oil via extensive processing, such as solvent extraction, solvent or catalytic dewaxing, and hydroisomerization, hydrocracking and isodewaxing, isodewaxing and hydrofinishing. See “New Lubes Plants Use State-of-the-Art Hydrodewaxing Technology” in Oil & Gas Journal, Sep. 1, 1997; Krishna et al., “Next Generation Isodewaxing and Hydrofinishing Technology for Production of High Quality Base Oils”, 2002 NPRA Lubricants and Waxes Meeting, Nov. 14-15, 2002; Gedeon and Yenni, “Use of “Clean” Paraffinic Processing Oils to Improve TPE Properties”, Presented at TPEs 2000 Philadelphia, Pa., Sep. 27-28, 1999.

Group III base stocks can also be produced from synthetic hydrocarbon liquids obtained from natural gas, coal or other fossil resources, Group IV base stocks are polyalphaolefins (PAOs), and are produced by oligomerization of alpha olefins, such as 1-decene. Group V base stocks include all base stocks that do not belong to Groups I-IV, such as naphthenics, polyalkylene glycols (PAG), and esters.

TABLE 1

| API Classification | Group I | Group II | Group III | Group IV | Group V |
|---|---|---|---|---|---|
| % Saturates | <90 | ≥90 | ≥90 | Polyalphaolefins | All others not |
| % S | >0.03 | ≤0.03 | ≤0.03 | (PAOs) | belonging to |
| Viscosity Index (VI) | 80-120 | 80-120 | ≥120 | | Groups I-IV |

In some embodiments, synthetic oils can include polymers and oligomers of butenes including isobutene, 1-butene, 2-butene, butadiene, and mixtures thereof. In some embodiments, these oligomers can be characterized by a number average molecular weight (Mn) of from about 300 g/mol to about 9,000 g/mol, and in other embodiments from about 700 g/mol to about 1,300 g/mol. In some embodiments, these oligomers can include isobutenyl mer units. Example synthetic oils can include polyisobutylene, poly(isobutylene-co-butene), and mixtures thereof. In some embodiments, synthetic oils can include polylinear α-olefins, poly-branched α-olefins, hydrogenated polyalphaolefins, and mixtures thereof.

In some embodiments, the synthetic oils can include synthetic polymers or copolymers having a viscosity of about 20 cp or more, such as about 100 cp or more, such as about 190 cp or more, where the viscosity is measured by a Brookfield viscometer according to ASTM D-4402 at 38° C. In these or other embodiments, the viscosity of these oils can be about 4,000 cp or less, such as about 1,000 cp or less.

Useful synthetic oils can be commercially obtained under the tradenames Polybutene™ (Soltex; Houston, Tex.), and Indopol™ (Ineos), such as Indopol™ H-100. White synthetic oil is available under the tradename SPECTRASYN™ (ExxonMobil), formerly SHF Fluids (Mobil), Elevast™ (ExxonMobil), and white oil produced from gas to liquid technology such as Risella™ X 415/420/430 (Shell) or Primol™ (ExxonMobil) series of white oils, e.g. Primol™ 352, Primol™ 382, Primol™ 542, or Marcol™ 82, Marcol™ 52, Drakeol™ (Pencero) series of white oils, e.g. Drakeol™ 34 or a combination thereof. Oils described in U.S. Pat. No. 5,936,028 can also be employed, which is incorporated by reference herein in its entirety.

In some embodiments, the addition of certain low to medium molecular weight (<10,000 g/mol) organic esters and alkyl ether esters to the present PMP compositions and/or TPV compositions can dramatically lower the Tg of the components and of the overall composition. The addition of certain low to medium molecular weight (<10,000 g/mol) organic esters and alkyl ether esters can improve the low temperature properties, particularly flexibility and strength. Particularly suitable esters can include monomeric and oligomeric aliphatic esters having a low molecular weight, such as an average molecular weight in a range from about 2,000 or below, such as about 600 or below. In certain aspects, the ester can be selected to be compatible, or miscible, with both the polyolefin and rubber components of the compositions, e.g., that the ester mixes with the other components to form a single phase. The esters found to be suitable can include monomeric alkyl monoesters, monomeric alkyl diesters, oligomeric alkyl monoesters, oligomeric alkyl diesters, monomeric alkylether monoesters, monomeric alkylether diesters, oligomeric alkylether monoesters, oligomeric alkylether diesters, and mixtures thereof. Polymeric aliphatic esters and aromatic esters, and phosphate esters, can be used.

Examples of esters which have been found satisfactory for use in the present PMP compositions and/or TPV compositions can include diisooctyldodecanedioate, dioctylsebacate, butoxyethyloleate, n-butyloleate, n-butyltallate, isooctyloleate, isooctyltallate, dialkylazelate, diethylhexylsebacate, alkylalkylether diester glutarate, oligomers thereof, and mixtures thereof. Other analogues expected to be useful in the present PMP compositions and/or TPV compositionscan include alkyl alkylether monoadipates and diadipates, monoalkyl and dialkyl adipates, glutarates, sebacates, azelates, ester derivatives of castor oil or tall oil, and oligomeric monoesters and diesters or monoalkyl and dialkyl ether esters therefrom. Isooctyltallate and n-butyltallate are useful. These esters can be used alone in the compositions, or as mixtures of different esters, or they can be used in combination with conventional hydrocarbon oil diluents or processing oils, e.g., paraffin oil. In certain embodiments, the amount of ester plasticizer in the PMP compositions and/or TPV compositions can be in a range from about 0.1 wt % to about 40 wt % based on a total weight of the PMP compositions and/or TPV compositions. In certain embodiments, the ester plasticizer is isooctyltallate. Such esters are available commercially as Plasthall™ available from Hallstar of Chicago, Ill. In certain embodiments, the ester plasticizer can be n-butyl tallate. In certain embodiments, the ester plasticizer can be isooctyl tallate. An example of isooctyl tallate is available commercially under the trade name Plasthall 100™ (Hallstar). In some embodiments, an ester plasticizer can be tridecyl tallate. An example of tridecyl tallate is available commercially under the trade name RX-13577™ (Hallstar).

In some embodiments are provided a pipe that includes an inner polymer sheath; one or more reinforcing layers; one or more internal polymer sheaths, the internal polymer sheaths being one or more outer protective sheaths, one or more intermediate sheaths, or a combination thereof; and an external polymer sheath, wherein the inner polymer sheath, the one or more internal polymer sheaths, the external polymer sheath, or a combination thereof comprises a composition comprising polymethylpentene. In these and other embodiments, the one or more reinforcing layers can be at least partially disposed around the inner polymer sheath; and/or the one or more internal polymer sheaths can be at least partially disposed around the one or more reinforcing layers; and/or the external polymer sheath is at least partially disposed around the one or more internal polymer sheaths. In these and other embodiments, the intermediate sheath can have a thickness from about 1 mm to about 10 mm. The pipe can be rigid or flexible, and can be used in an offshore and/or onshore application.

In these and other embodiments, the composition comprising polymethylpentene can further include a plasticizer, a processing oil, a thermal stabilizer, a UV stabilizer, a nucleator, or a combination thereof. The polymethylpentene can be a homopolymer of 4-methyl-1-pentene. Alternatively, the polymethylpentene can be a polymethylpentene copolymer of 4-methyl-1-pentene and a C₂-C₄₀ monomer (such as a C₂-C₂₀ monomer, such as ethylene, propylene, 1-butene, 1-hexene, 1-octene, 1-decene, 1-tetradecane, 1-octadecene, or a combination thereof), the C₂-C₄₀ monomer being different from 4-methyl-1-pentene. In these and other embodiments, the polymethylpentene can include about 40 wt % or less of units derived from a C₂-C₂₀ monomer, such as about 30 wt % or less of units derived from a C₂-C₂₀ monomer, such as about 20 wt % or less of units derived from a C₂-C₂₀ monomer. In these and other embodiments, the polymethylpentene can have a melt mass flow rate (5 kg, 260° C., ASTM D1238) of about 0.5 g/10 min to about 200 g/10 min, or about 0.5 g/10 min to about 100 g/10 min; a CO₂ gas permeability (60° C.) of about 10 barrers to about 50 barrers, or from about 50 barrers to 500 barrers, or from about 70 barrers to about 250 barrers, as measured according to ISO 2782-1; a thermal conductivity of about 0.05 W/m·K to about 0.2 W/m·K, or from about 0.10 W/m·K to about 0.195 W/m·K, or from about 0.15 W/m·K to about 0.19 W/m·K, or from about 0.155 W/m·K to about 0.185 W/m·K, as measured according to ASTM C177 (25° C.); a Young's modulus (ISO 37, 23° C., 50 mm/min) of about 100 MPa to about 1,700 MPa, or from about 300 MPa to about 1,600 MPa, or from about 400 MPa to about 1,500 MPa; a melt index (ASTM D1238-70, 5 kg weight @ 260° C.) of about 5 g/10 min to about 80 g/10 min; and/or a specific gravity (23° C., ASTM D792) of about 0.82 to about 0.85.

### Example Preparation of TPV Compositions

In some embodiments, the rubber can be cured or crosslinked by dynamic vulcanization. The term dynamic vulcanization refers to a vulcanization or curing process for a rubber contained in a blend with a thermoplastic resin, wherein the rubber is crosslinked or vulcanized under conditions of high shear at a temperature above the melting point of the thermoplastic polyolefin. The rubber can be cured by employing a variety of curatives. Example curatives can include phenolic resin cure systems, peroxide cure systems, and silicon-containing cure systems, such as hydrosilylation and silane grafting/moisture cure. Dynamic vulcanization can occur in the presence of the polyolefin, or the polyolefin can be added after dynamic vulcanization (e.g., post added), or both (e.g., some polyolefin can be added prior to dynamic vulcanization and some polyolefin can be added after dynamic vulcanization).

In some embodiments, the rubber can be simultaneously crosslinked and dispersed as fine particles within the thermoplastic matrix, although other morphologies can also exist. Dynamic vulcanization can be effected by mixing the thermoplastic vulcanizate components at elevated temperature in conventional mixing equipment such as roll mills, stabilizers, Banbury mixers, Brabender mixers, continuous mixers, mixing extruders, and the like. Methods for preparing TPV compositions are described in U.S. Pat. Nos. 4,311,628, 4,594,390, 6,503,984, and 6,656,693, each of which is incorporated by reference herein in its entirety, although methods employing low shear rates can also be used. Multiple-step processes can also be employed whereby ingredients, such as additional thermoplastic resin, can be added after dynamic vulcanization has been achieved as disclosed in International Application No. PCT/US2004/030517, which is incorporated by reference herein in its entirety.

In some embodiments, a process for the preparation of dynamically vulcanized thermoplastic vulcanizate can include melt processing under shear conditions at least one thermoplastic resin, at least one rubber, and at least one curing agent. In some embodiments, the melt processing can be performed under high shear conditions. Shear conditions are similar to conditions that exist when the TPV compositions are produced using common melt processing equipment such as Brabender or Banbury mixers (lab scale instruments) and commercial twin-screw extruders.

The word shear is added to indicate that various components of the TPV composition can be incorporated into TPV compositions by mixing under high shear temperature and intense mixing.

The skilled artisan will be able to readily determine a sufficient or effective amount of vulcanizing agent to be employed without undue calculation or experimentation.

As noted above, the TPV compositions can be dynamically vulcanized by a variety of methods including employing a cure system, wherein the cure system includes a curative, such as a phenolic resin curative, a peroxide curative, a maleimide curative, a hexamethylene diamine carbamate curative, a silicon-based curative (including hydrosilylation curative, a silane-based curative such as a silane grafting followed by moisture cure), metal oxide-based curative (such as ZnO for butyl rubbers), sulfur-based curative, or a combination thereof.

Useful phenolic cure systems are disclosed in U.S. Pat. Nos. 2,972,600, 3,287,440, 5,952,425 and 6,437,030, each of which is incorporated by reference herein in its entirety.

In some embodiments, phenolic resin curatives can include resole resins, which can be made by the condensation of alkyl substituted phenols or unsubstituted phenols with aldehydes, such as formaldehydes, in an alkaline medium or by condensation of bi-functional phenoldialcohols. The alkyl substituents of the alkyl substituted phenols can have from about 1 to about 10 carbon atoms, such as dimethylolphenols or phenolic resins, substituted in para-positions with alkyl groups having from about 1 to about 10 carbon atoms. In some embodiments, a blend of octylphenol-formaldehyde and nonylphenol-formaldehyde resins can be employed. The blend can include from about 25 wt % to about 40 wt % octylphenol-formaldehyde and from about 75 wt % to about 60 wt % nonylphenol-formaldehyde, such as from about 30 wt % to about 35 wt % octylphenol-formaldehyde and from about 70 wt % to about 65 wt % nonylphenol-formaldehyde. In some embodiments, the blend can include about 33 wt % octylphenol-formaldehyde and about 67 wt % nonylphenol-formaldehyde resin, where each of the octylphenol-formaldehyde and nonylphenol-formaldehyde include methylol groups. This blend can be solubilized in paraffinic oil at about 30% solids without phase separation.

Useful phenolic resins can be obtained under the tradenames SP-1044, SP-1045 (Schenectady International; Schenectady, N.Y.), which can be referred to as alkylphenol-formaldehyde resins.

An example of a phenolic resin curative can include that defined according to the general formula

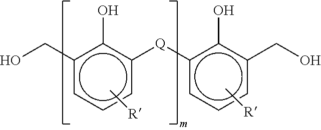

where Q can be a divalent radical selected from the group consisting of —CH₂—, —CH₂—O—CH₂—, m can be zero or a positive integer from 1 to 20 and R′ can be an organic group. In some embodiments, Q can be the divalent radical —CH₂—O—CH₂—, m can be zero or a positive integer from 1 to 10, and R′ can be an organic group having less than 20 carbon atoms. In other embodiments, m can be zero or a positive integer from 1 to 10 and R′ can be an organic radical having from 4 to 12 carbon atoms.

In some embodiments, the phenolic resin can be used in combination with a halogen source, such as stannous chloride, and metal oxide or reducing compound such as zinc oxide.

In some embodiments, the phenolic resin can be employed in an amount from about 2 parts by weight to about 6 parts by weight, such as from about 3 parts by weight to about 5 parts by weight, such as from about 4 parts by weight to about 5 parts by weight per 100 parts by weight of rubber. A complementary amount of stannous chloride can include from about 0.5 parts by weight to about 2.0 parts by weight, such as from about 1.0 parts by weight to about 1.5 parts by weight, such as from about 1.2 parts by weight to about 1.3 parts by weight per 100 parts by weight of rubber. In conjunction therewith, from about 0.1 parts by weight to about 6.0 parts by weight, such as from about 1.0 parts by weight to about 5.0 parts by weight, such as from about 2.0 parts by weight to about 4.0 parts by weight of zinc oxide can be employed. In some embodiments, the olefinic rubber employed with the phenolic curatives can include diene units deriving from 5-ethylidene-2-norbornene.

In some embodiments, useful peroxide curatives can include organic peroxides. Examples of organic peroxides include di-tert-butyl peroxide, dicumyl peroxide, t-butylcumyl peroxide, α,α-bis(tert-butylperoxy) diisopropyl benzene, 2,5-dimethyl-2,5-di(t-butylperoxy)hexane (DBPH), 1,1-di(tert-butylperoxy)-3,3,5-trimethyl cyclohexane, n-butyl-4-4-bis(tert-butylperoxy) valerate, benzoyl peroxide, lauroyl peroxide, dilauroyl peroxide, 2,5-dimethyl-2,5-di(tert-butylperoxy) hexyne-3, and mixtures thereof. Also, diaryl peroxides, ketone peroxides, peroxydicarbonates, peroxyesters, dialkyl peroxides, hydroperoxides, peroxyketals and mixtures thereof can be used. Useful peroxides and their methods of use in dynamic vulcanization of TPV compositions are disclosed in U.S. Pat. No. 5,656,693, which is incorporated by reference herein in its entirety.

In some embodiments, the peroxide curatives can be employed in conjunction with a coagent. Examples of coagents can include triallylcyanurate, triallyl isocyanurate, triallyl phosphate, sulfur, N-phenyl bis-maleamide, zinc diacrylate, zinc dimethacrylate, divinyl benzene, 1,2-polybutadiene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, and oximes such as quinone dioxime. In order to maximize the efficiency of peroxide/coagent crosslinking, the mixing and dynamic vulcanization can be carried out in a nitrogen atmosphere.

In some embodiments, silicon-containing cure systems can include silicon hydride compounds having at least two Si—H groups. Silicon hydride compounds that are useful in practicing the present disclosure can include methylhydrogenpolysiloxanes, methylhydrogendimethylsiloxane copolymers, alkylmethyl-co-methylhydrogenpolysiloxanes, bis(dimethylsilyl)alkanes, bis(dimethylsilyl)benzene, and mixtures thereof.

Useful catalysts for hydrosilylation can include transition metals of Group VIII. These metals can include palladium, rhodium, and platinum, as well as complexes of these metals. Useful silicon-containing curatives and cure systems are disclosed in U.S. Pat. Nos. 5,936,028, 4,803,244, 5,672,660, and 7,951,871, each of which is incorporated by reference herein in its entirety.

In some embodiments, the silane-containing compounds can be employed in an amount from about 0.5 parts by weight to about 5.0 parts by weight per 100 parts by weight of rubber, such as from about 1.0 parts by weight to about 4.0 parts by weight, such as from about 2.0 parts by weight to about 3.0 parts by weight. A complementary amount of catalyst can include from about 0.5 parts of metal to about 20.0 parts of metal per million parts by weight of the rubber, such as from about 1.0 parts of metal to about 5.0 parts of metal, such as from about 1.0 parts of metal to about 2.0 parts of metal. In some embodiments, the olefinic rubber employed with the hydrosilylation curatives can include diene units deriving from 5-vinyl-2-norbornene.

For example, a phenolic resin can be employed in an amount of about 2 parts by weight to about 10 parts by weight per 100 parts by weight rubber, such as from about 3.5 parts by weight to about 7.5 parts by weight, such as from about 5 parts by weight to about 6 parts by weight. In some embodiments, the phenolic resin can be employed in conjunction with stannous chloride and optionally zinc oxide. The stannous chloride can be employed in an amount from about 0.2 parts by weight to about 10 parts by weight per 100 parts by weight rubber, such as from about 0.3 parts by weight to about 5 parts by weight, such as from about 0.5 parts by weight to about 3 parts by weight. The zinc oxide can be employed in an amount from about 0.25 parts by weight to about 5 parts by weight per 100 parts by weight rubber, such as from about 0.5 parts by weight to about 3 parts by weight, such as from about 1 parts by weight to about 2 parts by weight.

Alternatively, in some embodiments, a peroxide can be employed in an amount from about 1×10⁻⁵ moles to about 1×10⁻¹ moles, such as from about 1×10⁻⁴ moles to about 9×10⁻² moles, such as from about 1×10⁻² moles to about 4×10⁻² moles per 100 parts by weight rubber. The amount can also be expressed as a weight per 100 parts by weight rubber. This amount, however, can vary depending on the curative employed. For example, where 4,4-bis(tert-butyl peroxy) diisopropyl benzene is employed, the amount employed can include from about 0.5 parts by weight to about 12 parts by weight, such as from about 1 parts by weight to about 6 parts by weight per 100 parts by weight rubber. The skilled artisan will be able to readily determine a sufficient or effective amount of coagent that can be used with the peroxide without undue calculation or experimentation. In some embodiments, the amount of coagent employed can be similar in terms of moles to the number of moles of curative employed. The amount of coagent can also be expressed as weight per 100 parts by weight rubber. For example, where the triallylcyanurate coagent is employed, the amount employed can include from about 0.25 phr to about 20 phr, such as from about 0.5 phr to about 10 phr, based on 100 parts by weight rubber.

### Slip Agent

In some embodiments, in addition to the rubber, thermoplastic resins, processing oils, and fillers, the present TPV compositions can optionally include a slip agent when the crosslinked rubber is cured with a phenolic or peroxide based cure systems. Slip agents can be defined as class of fillers or additives intended to reduce the coefficient of friction of the TPV composition while also improving the abrasion resistance. Examples of slip agents can include siloxane based additives (such as polysiloxanes), ultra-high molecular weight polyethylene, a blend of siloxane based additives (such as polysiloxanes) and ultra-high molecular weight polyethylene, molybdenum disulfide molybdenum disulfide, halogenated and unhalogenated compounds based on aliphatic fatty chains, fluorinated polymers, perfluorinated polymers, graphite, and a combination thereof. The slip agents can be selected with a molecular weight suitable for the use in oil, paste, or powder form.

Slip agents useful in the TPV compositions can include fluorinated or perfluorinated polymers, such as Kynar™ (available from Arkema of King of Prussia, Pa.), Dynamar™ (available from 3M of Saint Paul, Minn.), molybdenum disulfide, or compounds based on aliphatic fatty chains, whether halogenated or not, or polysiloxanes. In some embodiments, the slip agents can be of the migratory type or non-migratory type.

In some embodiments, the polysiloxane can include a migratory siloxane polymer which is a liquid at standard conditions of pressure and temperature. A suitable polysiloxane is a high molecular weight, essentially linear polydimethyl-siloxane (PDMS). Additionally, the polysiloxane can have a viscosity at room temperature in a range from about 100 to about 100,000 cSt, such as from about 1,000 to about 10,000 cSt, or from about 5,000 cSt to about 10,000 cSt.

In some embodiments, polysiloxane can additionally, or alternatively, contain R groups that are selected based on the cure mechanism desired for the composition containing the first polysiloxane. Typically, the cure mechanism is either by means of condensation cure or addition cure, but is generally via an addition cure process. For condensation reactions, two or more R groups per molecule should be hydroxyl or hydrolysable groups such as alkoxy group having up to about 3 carbon atoms. For addition reactions, and in some embodiments, two or more R groups per molecule can be unsaturated organic groups, typically alkenyl or alkynyl groups, such as up to about 8 carbon atoms. One suitable commercially available material useful as the first polysiloxane is XIAMETER™ PMX-200 Silicone Fluid available from Dow Corning Midland, Mich. In certain embodiments, the TPV compositions described herein can contain polysiloxane in a range from about 0.2 wt % to about 20 wt %, such as from about 0.5 wt % to about 15 wt % or from about 0.5 wt % to about 10 wt %.

In at least one embodiment, polysiloxane, such as polyorganosiloxanes, can be a non-migratory polysiloxane which is bonded to a thermoplastic material. The polysiloxane can be reactively dispersed in a thermoplastic material, which can be any homopolymer or copolymer of ethylene and/or α-olefins such as propylene, 1-butene, 1-hexene, 1-octene, 2-methyl-1-propene, 3-methyl-1-pentene, 4-methyl-1-pentene, 5-methyl-1-hexene, and mixtures thereof. In one embodiment, the thermoplastic material is a polypropylene homopolymer. Suitable methods of reactively bonding a polysiloxane to an organic thermoplastic polymer, such as a polyolefin, are disclosed in International Patent Publication Nos. WO 2015/132190 and WO 2015/150218, the entire contents of which are incorporated herein by reference for U.S. patent practice.

In some embodiments, the polysiloxane can include predominantly D and/or T units and can contain some alkenyl functionalities, which assist in the reaction with the polymer matrix. There is a covalent bond between the polysiloxane and the polypropylene. In some embodiments, the reaction product of polysiloxane and the polypropylene can have a number average molecular weight in a range from about 0.2 kg/mol to about 100 kg g/mole. The number average molecular weight of the reaction product of the polyorganosiloxane and the polymer matrix can be at least 1.1 times, such as at least 1.3 times, the number average molecular weight of the base polyorganosiloxane. In some embodiments, the second polyorganosiloxane can have a gum loading of in a range from about 20 wt % and about 50 wt %.

One example of a slip agent is HMB-0221. HMB-0221 is provided as pelletized concentrate containing reaction products of ultrahigh molecular weight siloxane polymer reactively dispersed in polypropylene homopolymer. HMB-0221 is available from Dow Corning of Midland, Mich. In certain embodiments, the TPV compositions described herein contain a non-migratory polysiloxane in a range from about 0.2 wt % to about 20 wt %, such as from about 0.2 wt % to about 15 wt % or from about 0.2 wt % to about 10 wt %.

### Example Properties of the TPV Compositions

In some embodiments, the TPV compositions useful in one or more layers of a flexible pipe or article can include one or more of the following properties.

In some embodiments, the TPV compositions can exhibit a carbon dioxide (CO₂) permeability (at 60° C.) of about 30 barrers or more, such as from about 40 barrers to about 500 barrers, such as from about 50 barrers to about 400 barrers, such as from about 75 barrers to about 300 barrers, such as from about 90 barrers to about 250 barrers, such as from about 100 barrers to about 225 barrers, such as from about 110 barrers to about 210 barrers.

In some embodiments, the TPV compositions can exhibit a stress at 100% strain (M100) of from about 1 to about 20 MPa, such as from about 1.5 to about 15 MPa, such as from about 2 to about 15 MPa.

In some embodiments, the TPV compositions can exhibit a yield strain of about 1% or more, such as about 3% or more, such as from about 5% to about 65% or more, such as from about 7% to about 45%, such as from about 7% to about 45%, such as from about 7% to about 45%, such as from about 7% to about 45%, 9% to about 40%, such as from about 11% to about 35%, such as from about 15% to about 30%, such as from about 20% to about 25%. In at least one embodiment, the TPV composition has a yield strain of 10% or more, such as from about 10% to about 90%.

In some embodiments, the TPV compositions can exhibit a tensile strength at yield of about 3 MPa or more, such as from about 5 MPa to about 20 MPa, such as from about 7 MPa to about 16 MPa, such as from about 9 MPa, such as about 14 MPa, such as from about 10 MPa to about 12 MPa.

In some embodiments, the TPV compositions can exhibit a Young's modulus of about 5 MPa or more, such as from about 25 MPa to about 500 MPa, such as from about 40 MPa to about 450 MPa, such as from about 50 MPa to about 425 MPa, such as from about 75 MPa to about 400 MPa, such as from about 100 MPa to about 375 MPa, such as from about 125 MPa to about 350 MPa, such as from about 150 MPa to about 325 MPa, such as from about 175 MPa to about 300 MPa, such as from about 200 MPa to about 275 MPa, such as from about 225 MPa to about 250 MPa.

In some embodiments, the TPV compositions can exhibit a thermal conductivity (25° C.) of about 0.40 W/mK or less, such as 0.35 W/m·K or less, such as 0.30 W/m·K or less, such as from about 0.05 W/m·K to about 0.275 W/m·K, such as from about 0.075 W/m·K to about 0.25 W/m·K, such as from about 0.1 W/m·K to about 0.225 W/m·K, such as from about 0.125 W/m·K to about 0.2 W/mK, such as from about 0.15 W/m·K to about 0.175 W/m·K.

In some embodiments, the TPV compositions can exhibit a thermal conductivity (130° C.) of about 0.40 W/m·K or less, such as 0.35 W/m·K or less, such as 0.30 W/m·K or less, such as from about 0.05 W/mK to about 0.275 W/m·K, such as from about 0.075 W/m·K to about 0.25 W/m·K, such as from about 0.1 W/m·K to about 0.225 W/m·K, such as from about 0.125 W/m·K to about 0.2 W/mK, such as from about 0.15 W/m·K to about 0.175 W/m·K.

In some embodiments, the TPV compositions can exhibit a specific gravity (ASTM D792) of about 0.8 or more, such as from about 0.81 to about 0.93, such as from about 0.82 to about 0.91, such as from about 0.83 to about 0.89, such as from about 0.84 to about 0.87. In some embodiments, the TPV compositions can exhibit a specific gravity (ASTM D792) of about 0.8 to about 0.86, such as from about 0.805 to about 0.855, such as from about 0.81 to about 0.85, such as from about 0.815 to about 0.845, such as from about 0.82 to about 0.84, such as from about 0.825 to about 0.835.

In some embodiments, the TPV composition can have a hardness that is from about 20 Shore A to about 70 Shore D, such as from about 40 Shore A to about 90 Shore A, such as from about 50 Shore A to about 85 Shore A, such as from about 55 Shore A to about 75 Shore A. Alternatively, the TPV composition can have a hardness that is from about 10 Shore D to about 90 Shore D, such as from about 25 Shore D to about 75 Shore D.

CO₂ Gas permeability was measured according to ISO 2782-1, in which the thickness of each sample was measured at 5 points homogeneously distributed over the sample permeation area. The compression molded test specimen was bonded onto the holders with suitable adhesive cured at the test temperature. The chamber was evacuated by pulling vacuum on both sides of the film. The high pressure side of the film was exposed to the test pressure with CO₂ gas at 60° C. The test pressure and temperature was maintained for the length of the test, recording temperature and pressure at regular intervals. The sample was left under pressure until steady state permeation has been achieved (3-5 times the time lag (τ)).

M100 is stress at 100% strain when measured at 500 mm/min, 23° C., and was measured according to ISO 37.

Specific gravity is measured according to ASTM D792.

Thermal conductivity was measured according to ASTM C₁₇₇ in which the method was performed on TA FOX50-190 instrument. Compression molded plastics plaques were die cut into disc specimens of two inch diameter. The specimens were measured at 25° C. Each material was measured in duplicate.

Young's Modulus, tensile strength at yield, and yield strain were measured according to ISO 37. The samples were tested using crosshead speed of 50 mm/min at 23° C. on a compression molded plastic plaque.

Shore A Hardness was measured using a Zwick automated durometer according to ASTM D2240 (5 sec. delay). Shore D Hardness was measured using a Zwick automated durometer according to ASTM D2240 (5 sec. delay).

GPC-4D Procedure: Molecular Weight, Comonomer Composition and Long Chain Branching Determination by GPC-IR Hyphenated with Multiple Detectors

Unless otherwise indicated, the distribution and the moments of molecular weight (Mw, Mn, Mw/Mn, etc.), the comonomer content (C₂, C₃, C₆, etc.) and the branching index (g′vis) are determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10-μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1-μm Teflon filter and degassed with an online degasser before entering the GPC instrument. The nominal flow rate is 1.0 ml/min and the nominal injection volume is 200 μL. The whole system including transfer lines, columns, and detectors are contained in an oven maintained at 145° C. The polymer sample is weighed and sealed in a standard vial with 80-μL flow marker (Heptane) added to it. After loading the vial in the autosampler, polymer is automatically dissolved in the instrument with 8 ml added TCB solvent. The polymer is dissolved at 160° C. with continuous shaking for about 1 hour for most PE samples or 2 hour for PP samples. The TCB densities used in concentration calculation are 1.463 g/ml at room temperature and 1.284 g/ml at 145° C. The sample solution concentration is from 0.2 to 2.0 mg/ml, with lower concentrations being used for higher molecular weight samples. The concentration (c), at each point in the chromatogram is calculated from the baseline-subtracted IR5 broadband signal intensity (I), using the following equation: c=βI, where β is the mass constant. The mass recovery is calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10M g/mole. The MW at each elution volume is calculated with following equation

$$log M = \frac{log ( {K}_{P S} / K )}{a + 1} + \frac{{a}_{PS} + 1}{a + 1} log {M}_{P S}$$

where the variables with subscript “PS” stand for polystyrene while those without a subscript are for the test samples. In this method, α^{PS}=0.67 and K_{PS}=0.000175 while a and K are for other materials as calculated as published in literature (Sun, T. et al. Macromolecules, 2001, 34, 6812), except that for purposes of the present disclosure, α=0.700 and K=0.0003931 for ethylene, propylene, diene monomer copolymers (Nota Bene: Example 1 below used K=0.000351 and α=0.701), α=0.695 and K=0.000579 for linear ethylene polymers, α=0.705 and K=0.0002288 for linear propylene polymers, α=0.695 and K=0.000181 for linear butene polymers, a is 0.695 and K is 0.000579*(1−0.0087*w2b+0.000018*(w2b)*2) for ethylene-butene copolymer where w2b is a bulk weight percent of butene comonomer, a is 0.695 and K is 0.000579*(1−0.0075*w2b) for ethylene-hexene copolymer where w2b is a bulk weight percent of hexene comonomer, and a is 0.695 and K is 0.000579*(1−0.0077*w2b) for ethylene-octene copolymer where w2b is a bulk weight percent of octene comonomer. Concentrations are expressed in g/cm³, molecular weight is expressed in g/mole, and intrinsic viscosity (hence K in the Mark-Houwink equation) is expressed in dL/g unless otherwise noted.

The comonomer composition is determined by the ratio of the IR5 detector intensity corresponding to CH₂ and CH₃ channel calibrated with a series of PE and PP homo/copolymer standards. In particular, this provides the methyls per 1,000 total carbons (CH₃/1000TC) as a function of molecular weight. The short-chain branch (SCB) content per 1000TC (SCB/1000TC) is then computed as a function of molecular weight by applying a chain-end correction to the CH₃/1000TC function, assuming each chain to be linear and terminated by a methyl group at each end. The weight % comonomer is then obtained from the following expression in which f is 0.3, 0.4, 0.6, 0.8, and so on for C₃, C₄, C₆, C₈, and so on comonomers, respectively.

w2=f*SCB/1000TC

The bulk composition of the polymer from the GPC-IR and GPC-4D analyses is obtained by considering the entire signals of the CH₃ and CH₂ channels between the integration limits of the concentration chromatogram. First, the following ratio is obtained.

$$Bulk IR ratio = \frac{Area of {CH}_{3} signal with in integration limits}{Area of {CH}_{2} signal within integration limits}$$

Then the same calibration of the CH₃ and CH₂ signal ratio, as mentioned previously in obtaining the CH₃/1000TC as a function of molecular weight, is applied to obtain the bulk CH3/1000TC. A bulk methyl chain ends per 1000TC (bulk CH3end/1000TC) is obtained by weight-averaging the chain-end correction over the molecular-weight range. Then

$$w 2 b = f * bulk CH 3 / 1000 TC bulk SCB / 1000 TC = bulk CH 3 / 1000 TC - bulk \frac{CH 3 end}{1000 T C}$$

and

bulk SCB/1000TC is converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.).

$$\frac{{K}_{o} c}{Δ R ( θ )} = \frac{1}{MP ( θ )} + 2 {A}_{2} c$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and Kₒ is the optical constant for the system:

$${K}_{o} = \frac{4 {π}^{2} {{n}^{2} ( dn / dc )}^{2}}{{λ}^{4} {N}_{A}}$$

where N_{A} is Avogadro's number, and (dn/dc) is the refractive index increment for the system. The refractive index, n=1.500 for TCB at 145° C. and λ=665 nm. For analyzing polyethylene homopolymers, ethylene-hexene copolymers, and ethylene-octene copolymers, dn/dc=0.1048 ml/mg and A2=0.0015; for analyzing ethylene-butene copolymers, dn/dc=0.1048*(1−0.00126*w2) ml/mg and A2=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η] at each point in the chromatogram is calculated from the equation [η]=ηₛ/c, where c is concentration and is determined from the IR5 broadband channel output. The viscosity MW at each point is calculated as

M=K_{PS}M^{α}^{_{PS}}⁺¹/[η],

where αₚₛ is 0.67 and K_{PS} is 0.000175.

The branching index (g′ᵥᵢₛ) is calculated using the output of the GPC-IR5-LS-VIS method as follows. The average intrinsic viscosity, [η]_{avg}, of the sample is calculated by:

$${[ η ]}_{a v g} = \frac{\sum {{c}_{i} [ η ]}_{i}}{\sum {c}_{i}}$$

where the summations are over the chromatographic slices, i, between the integration limits.

The branching index g′ᵥᵢₛ is defined as

$${g}_{vis}^{′} = \frac{{[ η ]}_{avg}}{K {M}_{v}^{α}}$$

where Mᵥ is the viscosity-average molecular weight based on molecular weights determined by LS analysis and the K and a are for the reference linear polymer, which are, for purposes of the present disclosure, α=0.700 and K=0.0003931 for ethylene, propylene, diene monomer copolymers, α=0.695 and K=0.000579 for linear ethylene polymers, α=0.705 and K=0.0002288 for linear propylene polymers, α=0.695 and K=0.000181 for linear butene polymers, a is 0.695 and K is 0.000579*(1−0.0087*w2b+0.000018*(w2b)\hat{ }2) for ethylene-butene copolymer where w2b is a bulk weight percent of butene comonomer, a is 0.695 and K is 0.000579*(1−0.0075*w2b) for ethylene-hexene copolymer where w2b is a bulk weight percent of hexene comonomer, and a is 0.695 and K is 0.000579*(1−0.0077*w2b) for ethylene-octene copolymer where w2b is a bulk weight percent of octene comonomer. Concentrations are expressed in g/cm³, molecular weight is expressed in g/mole, and intrinsic viscosity (hence K in the Mark-Houwink equation) is expressed in dL/g unless otherwise noted. Calculation of the w2b values is as discussed above.

Experimental and analysis details not described above, including how the detectors are calibrated and how to calculate the composition dependence of Mark-Houwink parameters and the second-virial coefficient, are described by T. Sun, P. Brant, R. R. Chance, and W. W. Graessley (Macromolecules, 2001, v. 34(19), pp. 6812-6820).

All molecular weights are weight average unless otherwise noted. All molecular weights are reported in g/mol unless otherwise noted.

### EMBODIMENTS LISTING

The present disclosure provides, among others, the following embodiments, each of which can be considered as optionally including any alternate embodiments:

Clause 1. A thermoplastic vulcanizate (TPV) composition, comprising:

a rubber and a thermoplastic polyolefin, the thermoplastic polyolefin comprising a polymethylpentene, the rubber being at least partially crosslinked.

Clause 2. The TPV composition of Clause 1, wherein the thermoplastic polyolefin further comprises a polypropylene.
Clause 3. The TPV composition of Clause 1 or Clause 2, wherein a concentration of the rubber is from about 10 wt % to about 80 wt % based on a combined weight of the rubber and the thermoplastic polyolefin, and a concentration of the thermoplastic polyolefin is from about 20 wt % to about 90 wt % based on the combined weight of the rubber and the thermoplastic polyolefin.
Clause 4. The TPV composition of any one of Clauses 1-3, wherein the thermoplastic polyolefin comprises polymethylpentene and polypropylene.
Clause 5. The TPV composition of Clause 4, wherein the concentration of the polymethypentene is from about 15 wt % to about 85 wt % based on a combined weight of the polymethylpentene and polypropylene.
Clause 6. The TPV composition of any one of Clauses 1-5, further comprising a plasticizer, a processing oil, or a combination thereof.
Clause 7. The TPV composition of Clause 6, wherein:

the processing oil is selected from the group consisting of mineral oil, paraffinic oil, polyisobutylene, synthetic oil, and a combination thereof and/or the plasticizer is a low molecular weight alkyl ester.

Clause 8. The TPV composition of Clause 6 or Clause 7, wherein the processing oil is a low molecular weight alkyl ester.
Clause 9. The TPV composition of any one of Clauses 6-8, wherein the processing oil is tridecyl tallate.
Clause 10. The TPV composition of any one of Clauses 6-9, wherein the processing oil is a polyisobutylene or polybutene oil.
Clause 11. The TPV composition of any one of Clauses 1-10, wherein the TPV composition further comprises a thermal stabilizer, a UV stabilizer, or a combination thereof.
Clause 12. The TPV composition of any one of Clauses 1-11, wherein the TPV composition further comprises a filler, a slip agent, a nucleating agent, or a combination thereof.
Clause 13. The TPV composition of Clause 12, wherein the filler comprises calcium carbonate, clay, silica, talc, titanium dioxide, carbon black, mica, wood flour, or a combination thereof.
Clause 14. The TPV composition of any one of Clauses 1-13, further comprising a cure system.
Clause 15. The TPV composition of Clause 14, wherein the cure system comprises a phenolic resin, a peroxide, a maleimide, a hexamethylene diamine carbamate, a silicon-based curative, a silane-based curative, metal oxide, a sulfur-based curative, or a combination thereof.
Clause 16. The TPV composition of Clause 14 or Clause 15, wherein the cure system comprises a metal oxide, and a phenolic resin curative.
Clause 17. The TPV composition of any one of Clauses 1-16, wherein the rubber is an ethylene propylene rubber, a butyl rubber, a halobutyl rubber, halogenated copolymer of a C₄ to C₇ isomonoolefin and a paraalkylstyrene, or a combination thereof.
Clause 18. The TPV composition of Clause 17, wherein the ethylene propylene rubber is an ethylene propylene diene monomer rubber.
Clause 19. The TPV composition of Clause 18, wherein the ethylene propylene diene monomer rubber comprises a diene that includes ethylidene norbornene, vinyl norbornene, or a combination thereof.
Clause 20. The TPV composition of Clause 17, wherein the butyl rubber is selected from the group consisting of isobutylene-isoprene rubber (IIR), brominated isobutylene-isoprene rubber (BIIR), chlorinated isobutylene-isoprene rubber (CIIR), halogenated copolymer of a C₄ to C₇ isomonoolefin and a paraalkylstyrene, and a combination thereof.
Clause 21. The TPV composition of Clause 20, wherein the butyl rubber is an isobutylene-paramethylstyrene rubber comprising from about 0.5 wt % to about 25 wt % paramethylstyrene based on the weight of the rubber.
Clause 22. The TPV composition of Clause 20, wherein the butyl rubber is an isobutylene-isoprene rubber comprising from about 0.5 wt % to about 30 wt % isoprene based on the weight of the rubber.
Clause 23. The TPV composition of Clause 20, wherein the butyl rubber is a brominated isobutylene-isoprene rubber, a chlorinated isobutylene-isoprene rubber, or a combination thereof comprising a percent by weight halogenation of about 0.3 wt % to about 7 wt % based on an entire weight of the rubber.
Clause 24. The TPV composition of any one of Clauses 1-23, wherein the polymethylpentene is a homopolymer of 4-methyl-1-pentene.
Clause 25. The TPV composition of any one of Clauses 1-24, wherein the polymethylpentene has a Young's Modulus (ISO 527, 23° C., 1 mm/min) of about 350 MPa to about 1500 MPa.
Clause 26. The TPV composition of any one of Clauses 1-25, wherein the polymethylpentene is a polymethylpentene copolymer of 4-methyl-1-pentene and a C₂-Cao monomer, the C₂-Cao monomer being different from 4-methyl-1-pentene.
Clause 27. The TPV composition of Clause 26, wherein the C₂-C₂₀ monomer is ethylene, propylene, 1-butene, 1-hexene, 1-octene, 1-decene, 1-tetradecane, 1-octadecene, or a combination thereof.
Clause 28. The TPV composition of any one of Clauses 1-27, wherein the polymethylpentene has at least one of the following properties:

a CO₂ gas permeability (60° C.) of about 10 barrers to about 500 barrers, or from about 10 barrers to about 50 barrers, or from about 50 barrers to about 500 barrers, or from about 70 barrers to about 250 barrers, as measured according to ISO 2782-1; or a thermal conductivity of about 0.05 W/m·K to about 0.2 W/m·K, or from about 0.10 W/m·K to about 0.195 W/m·K, or from about 0.15 W/m·K to about 0.19 W/m·K, or from about 0.155 W/m·K to about 0.185 W/m·K, as measured according to ASTM C₁₇₇ (25° C.).

Clause 29. The TPV composition of any one of Clauses 1-28, wherein the polymethylpentene has at least one of the following properties:

a melt mass flow rate (5 kg, 260° C., ASTM D1238) of about 0.5 g/10 min to about 200 g/10 min, or about 0.5 g/10 min to about 100 g/10 min;

a Young's modulus (ISO 37, 23° C., 50 mm/min) of about 100 MPa to about 1700 MPa, or from about 300 MPa to about 1600 MPa, or from about 400 MPa to about 1500 MPa;

a melt index (ASTM D1238-70, 5 kg weight @ 260° C.) of about 5 g/10 min to about 80 g/10 min; or

a specific gravity (23° C., ASTM D792) of about 0.82 to about 0.85.

Clause 30. The TPV composition of any one of Clauses 1-29, wherein the TPV composition has a hardness of about 70 Shore A to about 60 Shore D, wherein Shore A hardness and Shore D hardness is measured using a Zwick automated durometer according to ASTM D2240 with a 5 sec. delay.
Clause 31. A process for preparing a thermoplastic vulcanizate composition, comprising:

melt processing under shear conditions at least one thermoplastic polyolefin, at least one rubber, and at least one curing agent, the at least one thermoplastic polyolefin comprising polymethylpentene; and

forming a thermoplastic vulcanizate composition.

Clause 32. An insulated high-temperature transport conduit comprising:

a continuous steel pipe comprising one or more pipe sections, wherein the steel pipe has an outer surface and an inner surface; and

a first thermal insulation layer disposed over the outer surface of the steel pipe, wherein the first thermal insulation layer comprises a TPV composition of any of clauses 1-31 having a thermal conductivity of less than 0.2 W/m·K.

Clause 33. A pipe comprising:

an inner polymer sheath;

one or more reinforcing layers;

one or more internal polymer sheaths, the internal polymer sheaths being one or more outer protective sheaths, one or more intermediate sheaths, or a combination thereof; and

an external polymer sheath, wherein the inner polymer sheath, the one or more internal polymer sheaths, the external polymer sheath, or a combination thereof comprises a TPV composition of any of clauses 1-32.

Clause 34. The pipe of Clause 33, wherein the one or more reinforcing layers is at least partially disposed around the inner polymer sheath.
Clause 35. The pipe of Clause 33 or 34, wherein the one or more internal polymer sheaths is at least partially disposed around the one or more reinforcing layers.
Clause 36. The pipe of any one of Clauses 33-35, wherein the external polymer sheath is at least partially disposed around the one or more internal polymer sheaths.
Clause 37. The pipe of any one of Clauses 33-36, wherein the intermediate sheath has a thickness of about 2 mm to 30 mm, or from about 1 mm to about 10 mm.
Clause 38. The pipe of any one of Clauses 33-37, wherein the pipe is a flexible pipe.
Clause 39. The pipe of any one of Clauses 33-38, wherein the pipe is a rigid pipe.
Clause 40. A pipe comprising:

a thermal insulation layer comprising the TPV composition of any of clauses 1-30.

Clause 41. The pipe of Clause 40, wherein the thermal insulation layer has a thickness of about 2 mm to about 30 mm.
Clause 42. The pipe of Clause 40 or Clause 41, wherein the thermal insulation layer is disposed as layers wound from one or more tapes.
Clause 43. The pipe of any one of Clauses 40-42, wherein the thermal insulation layer further comprises glass microspheres.
Clause 44. The pipe of any one of Clauses 40-43, further comprising:

an inner polymer sheath;

one or more reinforcing layers at least partially disposed around the inner polymer sheath;

one or more internal polymer sheaths at least partially disposed around the one or more reinforcing layers; and

an external polymer sheath at least partially disposed around the one or more internal polymer sheaths.

Clause 45. The pipe of any one of Clauses 40-44, wherein the pipe is a flexible pipe.
Clause 46. The pipe of any one of Clauses 40-45, wherein the pipe is a rigid pipe.
Clause 47. An article, comprising:

a thermal insulation layer comprising the TPV composition of any of Clauses 1-30; and

an electric vehicle car battery, an electronic, a heater, or a combination thereof.

### EXAMPLES

The Tables below set forth the ingredients and amounts (parts per hundred rubber, phr) employed in each sample and the results of physical testing of the compositions of the present disclosures and comparative examples. Those samples that correspond with the present disclosure are designated with “Ex.,” and those that are comparative are designated with the letter “C.”

Procedures or standards used for measuring various properties listed in the Tables below were performed as described above.

### A. Example PMP Resins

Table 2 sets forth physical testing—CO₂ permeability, thermal conductivity, and other mechanical and physical properties—performed on example PMP compositions according to embodiments of the present disclosure and comparative compositions. C.Ex. 1 is a polyamide-11 (Rilsan BESNO TL40 from Arekema). C.Ex. 2 is high density polyethylene Eltex™ TUB grade HDPE available from Ineos. C.Ex. 3 is a polypropylene homopolymer having a melt mass-flow rate (MFR) (230° C., 2.16 kg, ASTM D1238) of 0.6 g/10 min (commercially available as PP5341E1 (ExxonMobil)).

Ex. 1 is a commercially available polymethylpentene resin having a melt mass-flow rate (MFR) (260° C., 5 kg, ASTM D1238) of 26 g/10 min, a Young's Modulus of 1660 MPa, and a Vicat Softening point of 167° C. (ISO 306) (available under the trade name TPX™ RT18 (Mitsui). Ex. 2 is a commercially available polymethylpentene resin having a MFR (260° C., 5 kg, ASTM D1238) of 25 g/10 min, a Young's Modulus of 830 MPa, and a Vicat Softening point of 151° C. (ISO 306) (available under the trade name TPX™ MX002 (Mitsui). Ex. 3 is a commercially available polymethylpentene resin having a Young's Modulus of 1240 MPa, and a Vicat Softening point of 161° C. (ISO 306) (available under the trade name TPX™ MX004 (Mitsui).

The samples in Table 2 were prepared by compression molding. A Wabash press, model 12-1212-2 TMB was used for compression molding, with 4.5″×4.5″×0.06″ mold cavity dimensions in a 4-cavity Teflon-coated mold. Material in the mold was initially preheated at about 400° F. (204.4° C.) for about 2-2.5 minutes at a 2-ton pressure on a 4″ ram, after which the pressure was increased to 10-tons, and heating was continued for about 2-2.5 minutes more. The mold platens were then cooled with water, and the mold pressure was released after cooling (140° F.). Dog-bones were cut out of the molded (aged at room temperature for 24 hours) plaque for tensile testing (0.16″ width, 1.1″ test length (not including tabs at end)).

TABLE 2

| Material Properties | Test Method | C. Ex. 1 | C. Ex. 2 | C. Ex. 3 | Ex. 1 | Ex. 2 | Ex. 3 |
|---|---|---|---|---|---|---|---|
| Stress @ 7%, MPa | ISO 37 | 15.6 | 22.9 | 30.3 | 26.7 | 17.2 | 22.4 |
| Yield Strength, MPa | ISO 37 | 25.3 | 23.2 | 31.2 | 27.1 | 17.2 | 22.4 |
| Yield Strain, % | ISO 37 | 50.7 | 9.4 | 10.5 | 5.7 | 7.4 | 7.1 |
| Young’s Modulus, MPa | ISO 37 | 400 | 1330 | 1555 | 1662 | 828 | 1241 |
| CO₂ Gas Permeability, | ISO 2782-1 | 6.1 | 9.1 | 7.6 | 82.3 | 102 | 90.2 |
| Barrer | | | | | | | |
| Thermal conductivity, | ASTM C177 | 0.248 | 0.381 | 0.200 | 0.17 | 0.17 | 0.17 |
| W/m · K | | | | | | | |
| Specific gravity | ASTM D792 | 1.005 | 0.960 | 0.903 | 0.832 | 0.835 | 0.835 |

Numerical values in the table are modified by “about” or “approximately” the indicated value.

The results show that PMP alone can be used for the intermediate and/or external layers of flexible pipes for transporting hydrocarbons. The PMP example resins have the lowest specific gravity and can provide the extruded flexible pipe with a significant weight reduction relative to conventional polyamides, polypropylenes, and HDPE, which can be beneficial for transportation and installation offshore. For example, the example PMP resins have a specific gravity of about 0.83, while the conventional resins are above about 0.9, or even about 1.0. In addition, the example PMP resins exhibit a gas permeability that is about 10-17 times that of the comparative resins. For example, Ex. 2 has a CO₂ gas permeability of about 102 barrers while the polyamide, C.Ex. 1, has a gas permeability of about 6.1 barrers. PMP possesses bulky side chains resulting in low packing density of the crystalline regions of the resin. The low packing density creates a large free volume with high gas permeability. The example PMP resins also show substantially lower thermal conductivity relative to the conventional resins. For example, the comparative polyamide resin and the comparative HDPE resin show a thermal conductivity that is about 50% higher and about 100% higher, respectively, than the example PMP resins. This substantially lower thermal conductivity can help reduce the thickness and the weight of the pipe by reducing the amount of insulation needed for the pipe. Each of these properties of the PMP resins—gas permeability, thermal conductivity, and density—are enhanced relative to the conventional resins, while the PMP resins retain similar tensile properties as that of the conventional resins.

### B. Example TPV Compositions

Tables 3-6 set forth the ingredients and amounts (parts per hundred rubber, phr) employed in each sample and the results of physical testing—CO₂ permeability, thermal conductivity, and other mechanical and physical properties of the inventive and comparative examples—that were performed on each sample. Those samples that correspond with the present disclosure are designated with “Ex.,” and those that are comparative are designated with “C.Ex.”

### Sample Preparation Using a Brabender Mixer

TPV compositions were made in a laboratory Brabender-Plasticorder (model EPL-V5502) of 300 cc capacity at 100 rpm motor speed, and metal set temperature of 180° C. for comparative TPV compositions based on PP and at 250° C. for example TPV compositions having PMP. At time zero the rubber, clay, plastic, fillers and part of oil were charged. After about 4-5 minutes of fluxing, cure system was added and dynamic vulcanization was continued for about 4-5 minutes. Another 1/3 oil was added (where applicable) at around 10 minutes and mixing was continued for a total batch time of about 15 minutes.

A Wabash press, model 12-1212-2 TMB was used for compression molding, with 4.5″×4.5″×0.06″ mold cavity dimensions in a 4-cavity Teflon-coated mold. Material in the mold was initially preheated at about 400° F. (204.4° C.) for about 2-2.5 minutes at a 2-ton pressure on a 4″ ram, after which the pressure was increased to 10-tons, and heating was continued for about 2-2.5 minutes more. The mold platens were then cooled with water, and the mold pressure was released after cooling (140° F.). Dog-bones were cut out of the molded (aged at room temperature for 24 hours) plaque for tensile testing (0.16″ width, 1.1″ test length (not including tabs at end)).

EPDM1 is a commercially obtained 75 phr oil extended rubber, having a C₂ content of 64 wt %, an ethylidene norbornene (ENB) content of 4.5 wt %, and a Mooney ML(1+4) at 125° C.=52.

EPDM2 is a commercially obtained non-oil extended rubber, having a C₂ content of 57.5 wt %, an ethylidene norbornene (ENB) content of 8.9 wt %, and a Mooney ML(2+8) at 150° C.=92.

PP1 is a commercially obtained polypropylene homopolymer having a melt mass-flow rate (MFR) (230° C., 2.16 kg, ASTM D1238) of 0.6 g/10 min (commercially available as PP5341E1 (ExxonMobil)).

Butyl Rubber 1 is a commercially available butyl rubber, specifically a brominated copolymer of isobutylene and paramethylstyrene, ML (1+8) at 125° C.=45, 1.2 mol % benzylic bromine and a specific gravity of 0.93 available under the trade name Exxpro™ 3745 (ExxonMobil).

PMP1 is the polymethylpentene identified as Ex.1. PMP2 is the polymethylpentene identified as Ex.2.

SnCl₂ (MB) is an anhydrous stannous chloride polypropylene masterbatch. The SnCl₂ MB contains 45 wt % stannous chloride and 55 wt % of polypropylene having an MFR of 0.8 g/10 min (ASTM D1238; 230° C. and 2.16 kg weight).

Zinc oxide (ZnO) is Kadox 911.

The phenolic curative (a phenolic resin in oil, 30 wt % phenolic resin).

Clay is a calcined clay obtained under the tradename Icecap™ K Clay (available from Burgess).

Oils used for some samples includes a commercially obtained paraffinic Group II oil having a kinematic viscosity (40° C.) of 108 cSt under the trade name Paramount 6001R™ (Chevron Phillips), and a commercially obtained polybutene based oil under the trade name Indopol H-100™ (Palmer Holland).

Plasticizer used for some samples is a commercially obtained alkyl-based plasticizer, monoester (tridecyl tallate) available under the trade name RX-13577™ (Hallstar).

Table 3 shows conventional TPV compositions based on EPDM rubber and polypropylene thermoplastic resin.

TABLE 3

| | Test Method | C. Ex. 4 | C. Ex. 5 | C. Ex. 6 |
|---|---|---|---|---|
| Formulation (parts per | | | | |
| hundred rubber [symbol] ) | | | | |
| EPDM1 | | 175 | 175 | 175 |
| PP1 | | 451 | 234.84 | 142.22 |
| Clay | | 5 | 12 | 12 |
| ZnO | | 2 | 2 | 2 |
| Phenolic resin in oil | | 12.82 | 14 | 14 |
| SnCl₂ (MB) | | 1.67 | 2.22 | 1.67 |
| Paraffinic Group II oil | | 49.99 | 55.5 | 52.06 |
| Total (phr) | | 697.48 | 517.56 | 420.95 |
| Properties | | | | |
| Yield Strength, MPa | ISO 37 | 12.4 | No yield | No yield |
| Yield Strain, % | ISO 37 | 27.4 | No yield | No yield |
| Young's Modulus, MPa | ISO 37 | 400 | 170 | 90 |
| CO₂ Gas | ISO 2782-1 | 47 | 110 | 153 |
| Permeability | | | | |
| (60° C.), Barrer | | | | |
| Thermal conductivity | ASTM C177 | 0.186 | 0.185 | 0.190 |
| (25° C.), W/m · K | | | | |
| Thermal conductivity | ASTM C177 | 0.177 | — | — |
| (130° C.), W/m · K | | | | |
| Specific gravity | ASTM D792 | 0.898 | 0.902 | 0.909 |

Numerical values in the table are modified by “about” or “approximately” the indicated value. [symbol]
Parts per hundred rubber (phr) is based on the rubber phase. The TPV formulations assume that rubber is 100 phr (parts per hundred dry rubber, e.g., rubber without the oil extension).

Table 4 shows example TPV compositions made from polymethylpentene and EPDM rubber according to at least one embodiment of the present disclosure. Here, the polypropylene homopolymer (PP1) is either replaced fully or partially with the polymethylpentene resin, and two types of EPDM rubber are used for the samples—EPDM 1 and EPDM 2—the properties of which are described above.

TABLE 4

| Formulation | | | | | | | | |
|---|---|---|---|---|---|---|---|---|
| (parts per | | | | | | | | |
| hundred rubber [symbol] ) | | Ex. 4 | Ex. 5 | Ex. 6 | Ex. 7 | Ex. 8 | Ex. 9 | Ex. 10 |
| EPDM1 | | 175 | 175 | 175 | 175 | — | — | — |
| EPDM2 | | — | — | — | — | 100 | 100 | 100 |
| PP1 | | — | — | 315.7 | 315.7 | — | — | 315.7 |
| PMP1 | | 451 | — | 135.3 | — | 451 | — | — |
| PMP2 | | — | 451 | — | 135.3 | — | 451 | 135.3 |
| Clay | | 5 | 5 | 5 | 5 | 5 | 5 | 5 |
| ZnO | | 2 | 2 | 2 | 2 | 2 | 2 | 2 |
| Phenolic resin in | | 12.82 | 12.82 | 12.82 | 12.82 | 12.82 | 12.82 | 12.82 |
| oil | | | | | | | | |
| SnCl₂ (MB) | | 1.67 | 1.67 | 1.67 | 1.67 | 1.67 | 1.67 | 1.67 |
| Paraffinic Group II | | 49.99 | 49.99 | 49.99 | 49.99 | — | — | — |
| oil | | | | | | | | |
| Plasticizer | | — | — | — | — | 125 | 125 | 125 |
| Total (phr) | | 697.48 | 697.48 | 697.48 | 697.48 | 697.48 | 697.48 | 697.48 |
| Properties | Test Method | | | | | | | |
| Yield Strength, | ISO 37 | 7.0 | 5.1 | 9.3 | 9.6 | 5.8 | 4.6 | 9.3 |
| MPa | | | | | | | | |
| Yield Strain, % | ISO 37 | 10.4 | 26.3 | 11.8 | 27.5 | 6.1 | 35.8 | 38.2 |
| Young’s Modulus, | ISO 37 | 329 | 158 | 408 | 295 | 412 | 115 | 248 |
| MPa | | | | | | | | |
| CO₂ Gas | ISO 2782-1 | 114 | 143 | 69 | 78 | 197 | 199 | 116 |
| Permeability | | | | | | | | |
| (60° C.), Barrer | | | | | | | | |
| Thermal | ASTM | 0.153 | 0.152 | 0.180 | 0.175 | 0.151 | 0.156 | 0.173 |
| conductivity | C177 | | | | | | | |
| (25° C.), W/m · K | | | | | | | | |
| Thermal | ASTM | 0.155 | 0.152 | 0.172 | 0.170 | 0.151 | 0.152 | 0.169 |
| conductivity | C177 | | | | | | | |
| (130° C.), W/m · K | | | | | | | | |
| Specific gravity | ASTM | 0.849 | 0.850 | 0.883 | 0.885 | 0.844 | 0.855 | 0.888 |
| | D792 | | | | | | | |

Numerical values in the table are modified by “about” or “approximately” the indicated value. [symbol]
Parts per hundred rubber (phr) is based on the rubber phase. The TPV formulations assume that rubber is 100 phr (parts per hundred dry rubber, e.g., rubber without the oil extension).

The results in Table 4 show that TPV compositions that include PMP resin and EPDM rubber can be used for one or more layers of flexible pipes for transporting hydrocarbons. As compared to comparatives C.Ex.4, C.Ex.5, and C.Ex.6 (Table 3), the examples have a lower specific gravity and can provide the extruded flexible pipe with a significant weight reduction relative to conventional materials. Such a property can be beneficial for, at least, transportation and installation offshore. For example, the example TPV compositions have a specific gravity of about 0.888 or lower, while the conventional TPV compositions have specific gravities above 0.898, or almost 0.91. In addition, the example TPV compositions rival or surpass conventional TPV compositions in terms of gas permeability. For example, Ex.9 has a CO₂ gas permeability of about 199 barrers. Moreover, when comparing the CO₂ gas permeability between samples having a similar Young's Modulus, the examples of the present disclosure show much better CO₂ gas permeability. For example, C.Ex.4 has a Young's Modulus of about 400 and a CO₂ gas permeability of about 47 barrers, while Ex. 6 and Ex. 8 have similar values for Young's Modulus but a much higher CO₂ gas permeability of about 69 barrers and 197 barrers, respectively. PMP possesses bulky side chains resulting in low packing density of the crystalline regions of the resin. The low packing density creates a large free volume with high gas permeability. The example TPV also show substantially lower thermal conductivity relative to the conventional TPV compositions, exhibiting thermal conductivities at 25° C. of less than 0.18 W/m·K, or less than 0.17 W/m·K, or less than 0.16 W/m·K, or about 0.15 W/m less. The conventional TPV compositions shown in Table 3 have thermal conductivities well above these values, such as higher than 0.185 W/m·K. This substantially lower thermal conductivity can help reduce the thickness and the weight of the pipe by reducing the amount of insulation needed for the pipe. Each of these properties of the example TPV compositions—gas permeability, thermal conductivity, and density—are enhanced relative to the conventional TPV compositions, while the example TPV compositions retain similar tensile properties as that of the conventional TPV compositions.

Table 5 shows comparative TPV compositions made from butyl rubber (Butyl Rubber 1) and a polypropylene homopolymer (PP1). Table 5 also shows example TPV compositions made from polymethylpentene and butyl rubber (Butyl Rubber 1) according to at least one embodiment of the present disclosure. Here, the polypropylene homopolymer (PP1) is either replaced fully or partially with the polymethylpentene resin.

TABLE 5

| Formulation (parts per | | C. Ex. | C. Ex. | C. Ex. | C. Ex. | Ex. | Ex. | Ex. | Ex. | Ex. |
|---|---|---|---|---|---|---|---|---|---|---|
| hundred rubber [symbol] ) | | 7 | 8 | 9 | 10 | 11 | 12 | 13 | 14 | 15 |
| Butyl Rubber 1 | | 100 | 100 | 100 | 100 | 100 | 100 | 100 | 100 | 100 |
| PP1 | | 164 | 164 | 164 | 68 | — | — | 114.8 | — | — |
| PMP1 | | — | — | — | — | 164 | — | — | 68 | — |
| PMP2 | | — | — | — | — | — | 164 | 49.2 | — | 68 |
| Clay | | 5 | 5 | 5 | 5 | 5 | 5 | 5 | 5 | 5 |
| ZnO | | 5 | 5 | 5 | 5 | 5 | 5 | 5 | 5 | 5 |
| MgO | | — | — | 2 | 2 | 2 | 2 | 2 | 2 | 2 |
| Stearic acid | | — | — | 1 | 1 | 1 | 1 | 1 | 1 | 1 |
| Phenolic resin in oil | | 14 | 14 | 14 | 14 | 14 | 14 | 14 | 14 | 14 |
| SnCl₂ (MB) | | — | — | 1.3 | 1.3 | 1.3 | 1.3 | 1.3 | 1.3 | 1.3 |
| Paraffinic Group II oil | | 54 | — | — | — | — | — | — | — | — |
| Polybutene based oil | | — | 54 | 54 | 64 | 54 | 54 | 54 | 64 | 64 |
| Total (phr) | | 342 | 342 | 346.3 | 260.3 | 346.3 | 346.3 | 346.3 | 260.3 | 260.3 |
| Properties | Test Method | | | | | | | | | |
| Hardness, Shore A/D | ASTM D2240, 5 | 38 D | 38 D | 39 D | 78 A | 35 D | 87 A | 34 D | 74 A | 64 A |
| | second delay | | | | | | | | | |
| M100, MPa | ISO 37 | 9.44 | 8.90 | 9.00 | 4.17 | Broke | 4.06 | Broke | 2.26 | 7.30 |
| Young’s Modulus, MPa | ISO 37 | 151 | 165 | 186 | 25 | 236 | 84 | 127 | 40 | 14 |
| CO₂ Gas Permeability | ISO 2782-1 | 29.1 | 17.5 | 8.4 | 13 | 40 | 46 | 10.1 | 16.3 | 29 |
| (60° C.), Barrer | | | | | | | | | | |
| Thermal conductivity | ASTM C177 | 0.163 | 0.154 | 0.158 | 0.142 | 0.136 | 0.143 | 0.153 | 0.133 | 0.133 |
| (25° C.), W/m · K | | | | | | | | | | |
| Thermal conductivity | ASTM C177 | 0.157 | 0.152 | 0.155 | 0.142 | 0.141 | 0.142 | 0.150 | 0.135 | 0.135 |
| (130° C.), W/m · K | | | | | | | | | | |
| Specific gravity | ASTM D792 | 0.930 | 0.935 | 0.939 | 0.893 | 0.896 | 0.893 | 0.927 | 0.921 | 0.917 |

Numerical values in the table are modified by “about″ or “approximately” the indicated value. [symbol]
Parts per hundred rubber (phr) is based on the rubber phase. The TPV formulations assume that rubber is 100 phr (parts per hundred dry rubber, e.g., rubber without the oil extension).

The results in Table 5 show that TPV compositions that include PMP resin and butyl rubber can be used for one or more layers of flexible pipes for transporting hydrocarbons. The example TPV compositions have a lower specific gravity than the comparatives and can provide the extruded flexible pipe with a significant weight reduction relative to conventional materials. Such a property can be beneficial for, at least, transportation and installation offshore. For example, the example TPV compositions have a specific gravity of less than 0.93 and less than 0.9, while the conventional TPV compositions have specific gravities above 0.893, above 0.93, or almost 0.94. In addition, the example TPV compositions rival or surpass conventional TPV compositions in terms of gas permeability. For example, Ex.12 has a CO₂ gas permeability of about 46 barrers, a much higher permeability than all of the comparative TPVs. The Young's Modulus and Shore hardness was similar or better than the comparatives. The example TPV also show substantially lower thermal conductivity relative to the conventional TPV compositions, exhibiting thermal conductivities at 25° C. of less than 0.153 W/m·K, or less than 0.14 W/m·K. The conventional TPV compositions have thermal conductivities well above these values, such as higher than 0.16 W/m·K. This substantially lower thermal conductivity can help reduce the thickness and the weight of the pipe by reducing the amount of insulation needed for the pipe. Each of these properties of the TPV compositions—gas permeability, thermal conductivity, and density—are enhanced relative to the conventional TPV compositions, while the example TPV compositions retain similar tensile properties as that of the conventional TPV compositions.

Thus, the PMP compositions and TPV compositions exhibit excellent gas permeability and thermal conductivity, and have excellent mechanical properties. The data reveal that, advantageously, the PMP resins and TPV compositions disclosed herein are useful materials for one or more layers, e.g., outer sheaths and intermediate sheaths, in flexible pipes particularly when enhanced permeability, light weight, and/or low thermal conductivity is desired.

All documents described herein are incorporated by reference herein, including any priority documents and/or testing procedures to the extent they are not inconsistent with this text. Further, all documents and references cited herein, including testing procedures, publications, patents, journal articles, etc. are herein fully incorporated by reference for all jurisdictions in which such incorporation is permitted and to the extent such disclosure is consistent with the description of the present disclosure. As is apparent from the foregoing general description and the specific embodiments, while forms of the embodiments have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “I” preceding the recitation of the composition, element, or elements and vice versa, e.g., the terms “comprising,” “consisting essentially of,” “consisting of” also include the product of the combinations of elements listed after the term.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

1-47. (canceled)

48. A thermoplastic vulcanizate (TPV) composition, comprising:
a rubber and a thermoplastic polyolefin, the thermoplastic polyolefin comprising a polymethylpentene, the rubber being at least partially crosslinked.

49. The TPV composition of claim 48, wherein a concentration of the rubber is from about 10 wt % to about 80 wt % based on a combined weight of the rubber and the thermoplastic polyolefin, and a concentration of the thermoplastic polyolefin is from about 20 wt % to about 90 wt % based on the combined weight of the rubber and the thermoplastic polyolefin.

50. The TPV composition of claim 48, wherein the thermoplastic polyolefin further comprises a polypropylene.

51. The TPV composition of claim 50, wherein the concentration of the polymethypentene is from about 15 wt % to about 85 wt % based on a combined weight of the polymethylpentene and polypropylene.

52. The TPV composition of claim 48, further comprising a plasticizer, a processing oil, or a combination thereof.

53. The TPV composition of claim 52, wherein:
the processing oil is selected from the group consisting of mineral oil, paraffinic oil, polyisobutylene, synthetic oil, and a combination thereof; and/or
the plasticizer is a low molecular weight alkyl ester.

54. The TPV composition of claim 52, wherein the processing oil is a low molecular weight alkyl ester, tridecyl tallate, a polyisobutylene or polybutene oil, or a combination thereof.

55. The TPV composition of claim 48, wherein the TPV composition further comprises a thermal stabilizer, a UV stabilizer, or a combination thereof.

56. The TPV composition of claim 48, wherein the TPV composition further comprises a filler, a slip agent, a nucleating agent, or a combination thereof.

57. The TPV composition of claim 56, wherein the filler comprises calcium carbonate, clay, silica, talc, titanium dioxide, carbon black, mica, wood flour, or a combination thereof.

58. The TPV composition of claim 48, further comprising a cure system.

59. The TPV composition of claim 58, wherein the cure system comprises a phenolic resin, a peroxide, a maleimide, a hexamethylene diamine carbamate, a silicon-based curative, a silane-based curative, metal oxide, a sulfur-based curative, or a combination thereof.

60. The TPV composition of claim 58, wherein the cure system comprises a metal oxide, and a phenolic resin curative.

61. The TPV composition of claim 48, wherein the rubber is an ethylene propylene rubber, a butyl rubber, a halobutyl rubber, halogenated copolymer of a C₄ to C₇ isomonoolefin and a paraalkylstyrene, or a combination thereof.

62. The TPV composition of claim 61, wherein the ethylene propylene rubber is an ethylene propylene diene monomer rubber.

63. The TPV composition of claim 61, wherein the butyl rubber is selected from the group consisting of isobutylene-isoprene rubber (IIR), brominated isobutylene-isoprene rubber (BIIR), chlorinated isobutylene-isoprene rubber (CIIR), halogenated copolymer of a C₄ to C₇ isomonoolefin and a paraalkylstyrene, and a combination thereof.

64. The TPV composition of claim 63, wherein the butyl rubber is an isobutylene-paramethylstyrene rubber comprising from about 0.5 wt % to about 25 wt % paramethylstyrene based on the weight of the rubber.

65. The TPV composition of claim 63, wherein the butyl rubber is an isobutylene-isoprene rubber comprising from about 0.5 wt % to about 30 wt % isoprene based on the weight of the rubber.

66. The TPV composition of claim 63, wherein the butyl rubber is a brominated isobutylene-isoprene rubber, a chlorinated isobutylene-isoprene rubber, or a combination thereof comprising a percent by weight halogenation of about 0.3 wt % to about 7 wt % based on an entire weight of the rubber.

67. The TPV composition of claim 48, wherein the polymethylpentene is a homopolymer of 4-methyl-1-pentene.

68. The TPV composition of claim 48, wherein the polymethylpentene has a Young's Modulus (ISO 527, 23° C., 1 mm/min) of about 350 MPa to about 1500 MPa.

69. The TPV composition of claim 48, wherein the polymethylpentene is a polymethylpentene copolymer of 4-methyl-1-pentene and a C₂-C₂₀ monomer, the C₂-C₂₀ monomer being different from 4-methyl-1-pentene.

70. The TPV composition of claim 48, wherein the polymethylpentene has at least one of the following properties:
a CO₂ gas permeability (60° C.) of about 10 barrers to about 500 barrers, as measured according to ISO 2782-1; or
a thermal conductivity of about 0.05 W/m K to about 0.2 W/m K, as measured according to ASTM C₁₇₇ (25° C.).

71. The TPV composition of claim 48, wherein the polymethylpentene has at least one of the following properties:
a melt mass flow rate (5 kg, 260° C., ASTM D1238) of about 0.5 g/10 min to about 200 g/10 min;
a Young's modulus (ISO 37, 23° C., 50 mm/min) of about 100 MPa to about 1700 MPa;
a melt index (ASTM D1238-70, 5 kg weight @ 260° C.) of about 5 g/10 min to about 80 g/10 min; or
a specific gravity (23° C., ASTM D792) of about 0.82 to about 0.85.

72. The TPV composition of claim 48, wherein the TPV composition has a hardness of about 70 Shore A to about 60 Shore D, wherein Shore A hardness and Shore D hardness is measured using a Zwick automated durometer according to ASTM D2240 with a 5 sec. delay.

73. An insulated high-temperature transport conduit comprising:
a continuous steel pipe comprising one or more pipe sections, wherein the steel pipe has an outer surface and an inner surface; and
a first thermal insulation layer disposed over the outer surface of the steel pipe, wherein the first thermal insulation layer comprises a TPV composition of claim 48 having a thermal conductivity of less than 0.2 W/m·K.

74. A pipe comprising:
an inner polymer sheath;
one or more reinforcing layers;
one or more internal polymer sheaths, the internal polymer sheaths being one or more outer protective sheaths, one or more intermediate sheaths, or a combination thereof; and
an external polymer sheath, wherein the inner polymer sheath, the one or more internal polymer sheaths, the external polymer sheath, or a combination thereof comprises a TPV composition of claim 48.

75. The pipe of claim 74, wherein the one or more reinforcing layers is at least partially disposed around the inner polymer sheath, wherein the one or more internal polymer sheaths is at least partially disposed around the one or more reinforcing layers, and/or wherein the external polymer sheath is at least partially disposed around the one or more internal polymer sheaths.

76. A pipe comprising:
a thermal insulation layer comprising the TPV composition of claim 48.

77. An article comprising:
a thermal insulation layer comprising the TPV composition of claim 48; and
an electric vehicle car battery, an electronic, a heater, or a combination thereof.
